(19) United States
(12) Patent Application Publication
(10) Pub. No.: US 2024/0061064 A1
(43) Pub. Date: Feb. 22, 2024

(54) Wireless Communication Device Environment Detection

(71) Applicant: Telefonaktiebolaget LM Ericsson (publ), Stockholm (SE)

(72) Inventors: Rohit Chandra, Solna (SE); Satyam Dwivedi, Solna (SE); Henrik Asplund, Stockholm (SE)

(21) Appl. No.: 18/260,367

(22) PCT Filed: Jan. 5, 2021
(86) PCT No.: PCT/SE2021/050004

§ 371 Date: Jul. 5, 2023

(51) Int. Cl. G01S 5/00

(52) U.S. Cl. CPC G01S 5/015

(57) ABSTRACT

Wireless communication equipment (12, 16) detects a targeted signature over time in a Doppler spread and/or an angular spread associated with a wireless communication device (12). Based on detecting the targeted signature, the wireless communication equipment (12, 16) detects a transition (14) by the wireless communication device (12) between an indoor environment (8) and an outdoor environment (6). In some embodiments, based on detecting the transition (14), the wireless communication equipment (12, 16) adapts one or more communication parameters, adjusts resources allocated to the wireless communication device (12), and/or initiates handover of the wireless communication device (12).

### TECHNICAL FIELD

The present application relates generally to wireless communication, and relates more particularly to detecting the type of environment in which a wireless communication device is located.

### BACKGROUND

A wireless communication network typically provides wireless coverage over an area that spans different types of environments. For example, a wireless communication network may provide wireless coverage over an area that spans both an outdoor environment and an indoor environment, which impact wireless signals differently. As a wireless communication device moves within the network's coverage area, then, the device's movement between indoor and outdoor environments imposes dynamic challenges on the network to provide consistent wireless communication service to the device.

### SUMMARY

Some embodiments herein detect a transition by a wireless communication device between an indoor environment and an outdoor environment, e.g., on a dynamic or real-time basis as the wireless communication device moves within the coverage area of a wireless communication network serving the device. Some embodiments detect such a transition based on detecting a targeted signature over time in radio signal characteristics associated with the wireless communication device, such as a targeted signature over time in a Doppler spread or angular spread associated with the wireless communication device. For example, the targeted signature over time in Doppler spread may capture a temporary drop in Doppler spread attributable to a temporary reduction in the device's speed as the device makes the transition between environments, e.g., where such speed reduction may be needed to go through a door or doorway separating the environments. Regardless, in some embodiments, one or more actions are performed based on detection of the device's transition between indoor and outdoor environments, where such action(s) may include for instance initiating handover of the device or adapting parameter(s) (e.g., coding rate) governing wireless communication for the device. Detecting the device's transition between indoor and outdoor environments may thereby advantageously improve the quality of experience and/or quality of service provided to the device as the device moves within the network's coverage area.

More particularly, embodiments herein include a method comprising detecting a targeted signature over time in a Doppler spread and/or an angular spread associated with a wireless communication device. The method further comprises, based on detecting the targeted signature, detecting a transition by the wireless communication device between an indoor environment and an outdoor environment.

In some embodiments, detecting the targeted signature comprises detecting a targeted signature overtime in a Doppler spread associated with the wireless communication device. In one or more of these embodiments, detecting the targeted signature over time in the Doppler spread comprises detecting a first sub-signature in the Doppler spread during a first time period, detecting a second sub-signature in the Doppler spread during a second time period after the first time period, and detecting a third sub-signature in the Doppler spread during a third time period after the second time period. In this case, the first, second, and third sub-signatures are sub-signatures of the targeted signature. In one or more of these embodiments, the first sub-signature in the Doppler spread is values of the Doppler spread being greater than or equal to a first upper threshold, the second sub-signature in the Doppler spread is values of the Doppler spread being less than or equal to a lower threshold, and the third sub-signature in the Doppler spread is values of the Doppler spread being greater than or equal to a second upper threshold. In this case, the first and second upper thresholds may coincide or may be different. In one or more of these embodiments, the lower threshold is less than or equal to 20% of the first upper threshold or the second upper threshold. Alternatively or additionally, in one or more of these embodiments, the values of the Doppler spread are time-averaged values of the Doppler spread.

In some embodiments, detecting the targeted signature alternatively or additionally comprises detecting a targeted signature over time in an angular spread (e.g., in a zenith domain) associated with the wireless communication device. In one or more of these embodiments, the targeted signature over time in the angular spread comprises values of the angular spread changing by at least a threshold amount over the course of a maximum time period. Alternatively or additionally, in one or more of these embodiments, the values of the angular spread are time-averaged values of the angular spread.

In some embodiments, the method further comprises, responsive to detecting the transition, detecting an indoor signature or an outdoor signature over time in the Doppler spread and/or the angular spread associated with the wireless communication device, and determining whether the wireless communication device is in an indoor environment or an outdoor environment based respectively on whether the indoor signature or the outdoor signature is detected. In one or more of these embodiments, the indoor signature comprises values of the angular spread being greater before the transition than after the transition. In this case, the outdoor signature comprises values of the angular spread being smaller before the transition than after the transition. In one or more of these embodiments, determining whether the wireless communication device is in an indoor environment or an outdoor environment is based further on whether a received signal power for the wireless communication device before the transition is greater or less than a received signal power for the wireless communication device after the transition.

In some embodiments, the method is performed by a network node in a wireless communication network serving the wireless communication device. In one or more of these embodiments, the method further comprises receiving, from the wireless communication device, one or more measurement reports that report the Doppler spread and/or the angular spread as measured by the wireless communication device over time on one or more signals received by the wireless communication device. In other embodiments, the method further comprises measuring the Doppler spread and/or angular spread over time on one or more signals received by the network node from the wireless communication device.

In other embodiments, the method is performed by the wireless communication device. In this case, the method may further comprise measuring the Doppler spread and/or the angular spread over time on one or more signals received by the wireless communication device. Alternatively or additionally, the method may further comprise reporting, to a network node, the occurrence of the detected transition and/or a presence of the wireless communication device in the indoor environment or the outdoor environment.

In some embodiments, the method further comprises, based on detecting the transition by the wireless communication device between an indoor environment and an outdoor environment, adapting one or more parameters that govern wireless communication to or from the wireless communication device, adjusting resources allocated to the wireless communication device, and/or triggering a decision about whether to hand over the wireless communication device between network nodes.

In some embodiments, the angular spread includes angular spread in a zenith domain.

In some embodiments, an indoor environment has some type of roof and an outdoor environment lacks any type of roof.

In some embodiments, an indoor environment is inside a building, and an outdoor environment is outside a building, wherein a building has a roof and walls.

Other embodiments herein include a wireless communication equipment configured to detect a targeted signature over time in a Doppler spread and/or an angular spread associated with a wireless communication device, and, based on detecting the targeted signature, detect a transition by the wireless communication device between an indoor environment and an outdoor environment.

In some embodiments, the wireless communication equipment is the wireless communication device.

In some embodiments, the wireless communication equipment is a network node in a wireless communication network serving the wireless communication device.

In some embodiments, the wireless communication equipment is configured to perform the steps described above.

Other embodiments herein include a computer program comprising instructions which, when executed on at least one processor of wireless communication equipment, cause the wireless communication equipment to perform the steps described above.

In some embodiments, a carrier containing the computer program comprises one of an electronic signal, optical signal, radio signal, or computer readable storage medium.

Other embodiments herein include a wireless communication equipment comprising communication circuitry and processing circuitry. The processing circuitry is configured to detect a targeted signature over time in a Doppler spread and/or or an angular spread associated with a wireless communication device, and, based on detecting the targeted signature, detect a transition by the wireless communication device between an indoor environment and an outdoor environment.

In some embodiments, the wireless communication equipment is the wireless communication device.

In some embodiments, the wireless communication equipment is a network node in a wireless communication network serving the wireless communication device.

In some embodiments, the processing circuitry configured to perform the steps described above.

Other embodiments herein include a method comprising detecting a targeted signature over time in a Doppler spread and/or an angular spread associated with a wireless communication device, and performing one or more actions based on detecting the targeted signature. In some embodiments, the one or more actions include triggering a decision about whether to hand over the wireless communication device between a network node associated with an indoor environment and a network node associated with an outdoor environment. Alternatively or additionally, the one or more actions include adapting one or more parameters that govern wireless communication to or from the wireless communication device. Additionally or alternatively, the one or more actions include adjusting resources allocated to the wireless communication device. Additionally or alternatively, the one or more actions include triggering a decision about whether to hand over the wireless communication device between network nodes.

In some embodiments, detecting a targeted signature comprises detecting a targeted signature overtime in a Doppler spread associated with the wireless communication device. In one or more of these embodiments, detecting the targeted signature over time in the Doppler spread comprises detecting a first sub-signature in the Doppler spread during a first time period, detecting a second sub-signature in the Doppler spread during a second time period after the first time period, and detecting a third sub-signature in the Doppler spread during a third time period after the second time period. In this case, the first, second, and third sub-signatures are sub-signatures of the targeted signature. In one or more of these embodiments, the first sub-signature in the Doppler spread is values of the Doppler spread being greater than or equal to a first upper threshold, the second sub-signature in the Doppler spread is values of the Doppler spread being less than or equal to a lower threshold, and the third sub-signature in the Doppler spread is values of the Doppler spread being greater than or equal to a second upper threshold. In this case, the first and second upper thresholds may coincide or may be different. In some embodiments, the lower threshold is less than or equal to 20% of the first upper threshold or the second upper threshold. Alternatively or additionally, in some embodiments, the values of the Doppler spread are time-averaged values of the Doppler spread.

In some embodiments, detecting a targeted signature alternatively or additionally comprises detecting a targeted signature over time in an angular spread (e.g., in a zenith domain) associated with the wireless communication device. In one or more of these embodiments, the targeted signature over time in the angular spread comprises values of the angular spread changing by at least a threshold amount over the course of a maximum time period. In one or more of these embodiments, the values of the angular spread are time-averaged values of the angular spread.

In some embodiments, the method is performed by a network node in a wireless communication network serving the wireless communication device. In one or more of these embodiments, the method further comprises receiving, from the wireless communication device, one or more measurement reports that report the Doppler spread and/or angular spread as measured by the wireless communication device over time on one or more signals received by the wireless communication device. In one or more of these embodiments, the method further comprises measuring the Doppler spread and/or angular spread over time on one or more signals received by the network node from the wireless communication device.

In some embodiments, the method is performed by the wireless communication device. In one or more of these embodiments, the method further comprises measuring the Doppler spread and/or angular spread over time on one or more signals received by the wireless communication device.

In some embodiments, the angular spread includes angular spread in a zenith domain.

Other embodiments herein include a wireless communication equipment configured to detect a targeted signature over time in a Doppler spread and/or an angular spread associated with a wireless communication device, and perform one or more actions based on detecting the targeted signature. In some embodiments, the one or more actions include triggering a decision about whether to hand over the wireless communication device between a network node associated with an indoor environment and a network node associated with an outdoor environment. Alternatively or additionally, the one or more actions include adapting one or more parameters that govern wireless communication to or from the wireless communication device. Additionally or alternatively, the one or more actions include adjusting resources allocated to the wireless communication device. Additionally or alternatively, the one or more actions include triggering a decision about whether to hand over the wireless communication device between network nodes.

In some embodiments, the wireless communication equipment is the wireless communication device.

In some embodiments, the wireless communication equipment is a network node in a wireless communication network serving the wireless communication device.

In some embodiments, the wireless communication equipment is configured to perform any of the steps described above.

Other embodiments herein include a computer program comprising instructions which, when executed on at least one processor of wireless communication equipment, cause the wireless communication equipment to perform any of the steps described above. In one or more of these embodiments, a carrier containing the computer program comprises one of an electronic signal, optical signal, radio signal, or computer readable storage medium.

Other embodiments herein include wireless communication equipment comprising communication circuitry and processing circuitry. The processing circuitry is configured to detect a targeted signature over time in a Doppler spread and/or an angular spread associated with a wireless communication device, and perform one or more actions based on detecting the targeted signature. In some embodiments, the one or more actions include triggering a decision about whether to hand over the wireless communication device between a network node associated with an indoor environment and a network node associated with an outdoor environment. Alternatively or additionally, the one or more actions include adapting one or more parameters that govern wireless communication to or from the wireless communication device. Additionally or alternatively, the one or more actions include adjusting resources allocated to the wireless communication device. Additionally or alternatively, the one or more actions include triggering a decision about whether to hand over the wireless communication device between network nodes.

In some embodiments, the wireless communication equipment is the wireless communication device. In some embodiments, the wireless communication equipment is a network node in a wireless communication network serving the wireless communication device. In one or more of these embodiments, the processing circuitry configured to perform any of the steps described above.

Other embodiments herein include a method performed by wireless communication equipment. The method comprises transmitting or receiving a report that reports a transition by a wireless communication device between an indoor environment and an outdoor environment. Additionally or alternatively, the method comprises transmitting or receiving a report that reports presence of the wireless communication device in the indoor environment or the outdoor environment.

Other embodiments herein include wireless communication equipment configured to transmit or receive a report that reports a transition by a wireless communication device between an indoor environment and an outdoor environment. Additionally or alternatively, the wireless communication equipment is configured to transmit or receive a report that reports a presence of the wireless communication device in the indoor environment or the outdoor environment.

Other embodiments herein include a computer program comprising instructions which, when executed on at least one processor of wireless communication equipment, cause the wireless communication equipment to transmit or receive a report that reports a transition by a wireless communication device between an indoor environment and an outdoor environment. Additionally or alternatively, the instructions which, when executed on at least one processor of wireless communication equipment, cause the wireless communication equipment to transmit or receive a report that reports a presence of the wireless communication device in the indoor environment or the outdoor environment. In one or more of these embodiments, a carrier containing the computer program comprises one of an electronic signal, optical signal, radio signal, or computer readable storage medium.

Other embodiments herein include wireless communication equipment comprising communication circuitry and processing circuitry. The processing circuitry is configured to transmit or receive a report that reports a transition by a wireless communication device between an indoor environment and an outdoor environment. Additionally or alternatively, the processing circuitry is configured to transmit or receive a report that reports a presence of the wireless communication device in the indoor environment or the outdoor environment.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of wireless communication equipment configured for detecting a transition by a wireless communication device between an indoor environment and an outdoor environment according to some embodiments.

FIG. 2A is a graphical diagram of a frequency spectrum of a transmit signal according to some embodiments.

FIG. 2B is a graphical diagram of a frequency spectrum of the transmit signal of FIG. 2A after the transmit signal has propagated through a multipath propagation channel according to some embodiments.

FIG. 3A is a graphical diagram of an indoor signature according to some embodiments.

FIG. 3B is a graphical diagram of an outdoor signature according to some embodiments.

FIG. 4 is a logic flow diagram of a process for detecting a transition between indoor and outdoor environments according to some embodiments.

FIG. 5 is a logic flow diagram of a method performed by wireless communication equipment according to some embodiments.

FIG. 6 is a logic flow diagram of a method performed by wireless communication equipment according to other embodiments.

FIG. 7 is a logic flow diagram of a method performed by wireless communication equipment according to yet other embodiments.

FIG. 8 is a block diagram of wireless communication equipment according to some embodiments.

FIG. 9 is a block diagram of a wireless communication network according to some embodiments.

FIG. 10 is a block diagram of a user equipment according to some embodiments.

FIG. 11 is a block diagram of a virtualization environment according to some embodiments.

FIG. 12 is a block diagram of a communication network with a host computer according to some embodiments.

FIG. 13 is a block diagram of a host computer according to some embodiments.

FIG. 14 is a flowchart illustrating a method implemented in a communication system, in accordance with one embodiment.

FIG. 15 is a flowchart illustrating a method implemented in a communication system, in accordance with one embodiment.

FIG. 16 is a flowchart illustrating a method implemented in a communication system, in accordance with one embodiment.

FIG. 17 is a flowchart illustrating a method implemented in a communication system, in accordance with one embodiment.

### DETAILED DESCRIPTION

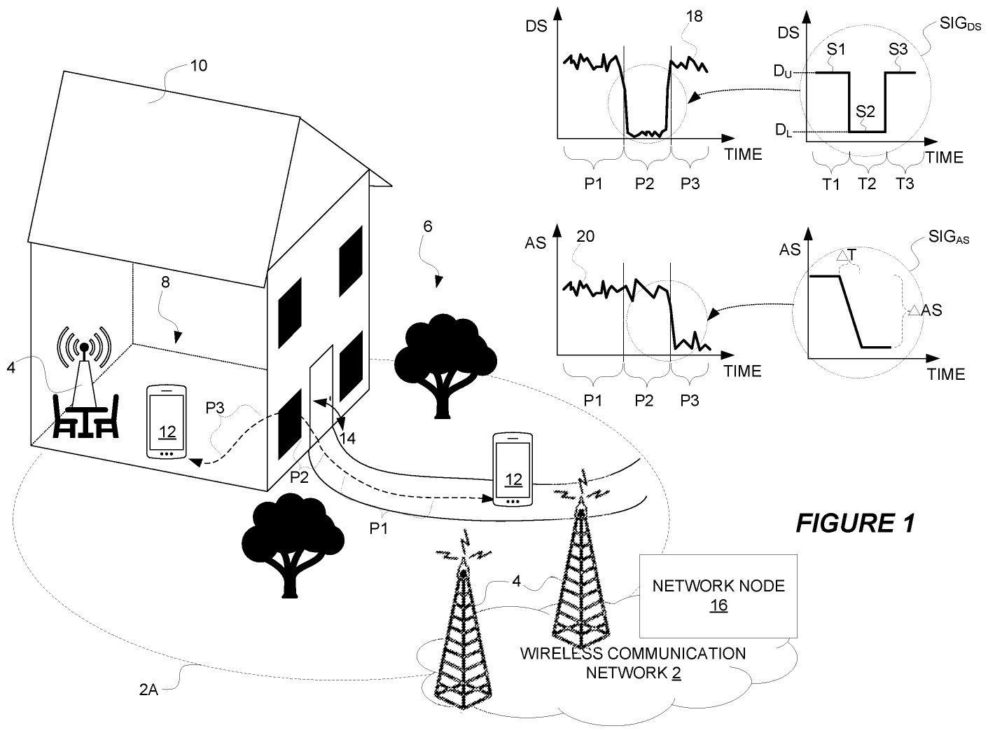

FIG. 1 shows a wireless communication network 2 that provides wireless communication service to wireless communication devices. The wireless communication network 2 in this regard includes radio network nodes 4 (e.g., base stations or access points) that provide wireless communication coverage over a coverage area 2A.

As shown, the coverage area 2A of the wireless communication network 2 extends over both an outdoor environment 6 and an indoor environment 8. The indoor environment 8 here is exemplified as being an environment inside a building 10 (e.g., a house, school, store, or factory), whereas the outdoor environment 6 is exemplified as being an environment outside of any building.

In this context, FIG. 1 shows that a particular wireless communication device 12 moves within the coverage area 2A over time, e.g., due to physical movement of the wireless communication device's user. By way of this movement, the wireless communication device 12 makes a transition 14 between the outdoor environment 6 and the indoor environment 8. This transition 14 may for example mean that the wireless communication device 12 transitions from being in the outdoor environment 6 at one time to being in the indoor environment 8 at another time, or vice versa. The transition 14 as shown in FIG. 1, for instance, may involve opening the door of the building 10 and proceeding through the doorway.

Some embodiments herein notably detect this transition 14 by the wireless communication device 12 between the indoor environment 8 and the outdoor environment 6. Detecting such transition 14 may for example mean detecting the occurrence of and/or timing of the wireless communication device's transition 14 between environments 6, 8, e.g., on a dynamic or real-time basis.

More particularly, some embodiments herein detect the transition 14 based on detecting a certain targeted signature over time in radio signal characteristics associated with the wireless communication device 12. That is, the radio signal characteristics change over time as the wireless communication device 12 makes the transition 14 between environments 6, 8, and some embodiments pinpoint a particular change in the radio signal characteristics as being a signature of the transition's occurrence and/or timing. Detection of the targeted signature is thereby indicative of the transition 14. Some embodiments accordingly target this signature for detection and base detection of the transition 14 on detection of the targeted signature.

Detection of the transition 14 may thereby be performed by any wireless communication equipment with access to the radio signal characteristics and the targeted signature. The wireless communication equipment that performs the transition detection may for instance be the wireless communication device 12 itself or be a network node 16 in the wireless communication network 2, e.g., where the network node 16 serves the wireless communication device 12. Although not limited to these examples, the wireless communication equipment that performs the transition detection is referred to herein for convenience as wireless communication equipment 12, 16.

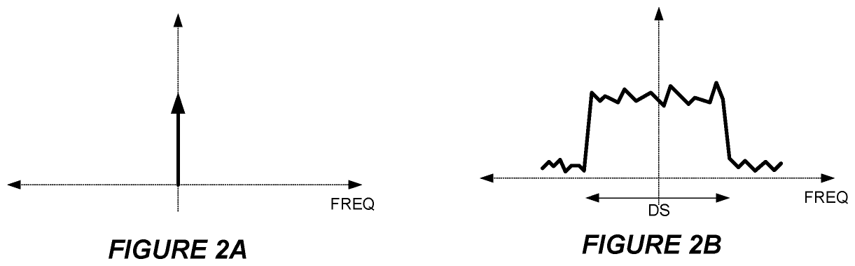

No matter what wireless communication equipment performs the transition detection, the radio signal characteristics on which that detection is based may include Doppler spread, for example. Doppler spread is a measure of the spectral broadening of a signal transmitted through a multipath propagation channel. FIGS. 2A-2B illustrate this. FIG. 2A shows that a signal to be transmitted has a narrow frequency spectrum. FIG. 2B shows that, after the signal is transmitted through a multipath propagation channel, the signal has a broader frequency spectrum due to Doppler spreading. This Doppler spread may be quantified for example as the value DS shown in FIG. 2B.

In embodiments that exploit Doppler spread, the wireless communication equipment 12, 16 bases detection of the transition 14 on detection of a targeted signature over time in the Doppler spread associated with the wireless communication device 12. In other words, the wireless communication equipment 12, 16 exploits changes over time in the Doppler spread as the wireless communication device 12 makes the transition 14 between environments 6, 8. The wireless communication equipment 12, 16 in this case pinpoints a particular change in the Doppler spread as being a signature of the transition's occurrence and/or timing. FIG. 1 shows an example.

In the example of FIG. 1, the wireless communication equipment 12, 16 bases detection of the transition 14 on detection of a targeted signature SIG_{DS} over time in the Doppler spread associated with the wireless communication device 12. The wireless communication equipment 12, 16 in particular obtains measured values 18 of the Doppler spread as shown, and effectively compares those measured values 18 to the targeted signature SIG_{DS} in an attempt to identify the targeted signature SIG_{DS} in the measured values 18 of the Doppler spread. Such comparison of the measured values 18 and the targeted signature SIG_{DS} may involve for instance correlating the measured values 18 with the targeted signature SIG_{DS}. Note, too, that the measured values 18 on which the comparison is performed may be raw values or filtered values. Here, the filtered values may be formed by filtering the raw values in one or more ways, e.g., the filtered values may be time-averaged values of the Doppler spread. In these and other cases, filtering may aim to reduce noise in the raw values of Doppler spread. Note further that the comparison may account for a margin of error between the targeted signature SIG_{DS} and the measured values 18. Regardless, if the targeted signature SIG_{DS} is not found within the measured values 18 of the Doppler spread, the wireless communication equipment 12,16 deduces that the wireless communication device 12 has not made the transition 14 between indoor and outdoor environments 6, 8. But, if on the other hand the targeted signature SIG_{DS} is found within the measured values 18 of the Doppler spread, the wireless communication equipment 12,16 deduces that the wireless communication device 12 has indeed made the transition 14 between indoor and outdoor environments 6, 8. Moreover, in some embodiments, this comparison is performed iteratively as new measured values 18 of the Doppler spread are obtained (e.g., in real-time), such that the time at which the targeted signature SIG_{DS} is detected more or less corresponds with or otherwise indicates the time at which the wireless communication device 12 makes the transition 14 between environments 6, 8.

In some embodiments, the targeted signature SIG_{DS} is formed from multiple sub-signatures in the Doppler spread during respective time periods. As shown, for example, the targeted signature SIG_{DS} is formed from three sub-signatures S1, S2, and S3 in the Doppler spread during three respective time periods T1, T2, and T3.

In the example of FIG. 1, sub-signature S1 is that measured values 18 of the Doppler spread are greater than or equal to an upper threshold D_{U}, whereas sub-signature S2 is that measured values 18 of the Doppler spread are less than or equal to a lower threshold D_{L}. In some embodiments, this lower threshold D_{L} is less than or equal to 20% (or 50%, or 40% or 30% or 10%) of the upper threshold D_{U}. Alternatively or additionally, this lower threshold DL may be set (e.g., to 0.5 Hz) to detect values of Doppler spread close to zero. However, the exact values of the upper threshold D_{U} and lower threshold D_{L} may depend on the carrier frequency or frequencies of the signal(s) whose Doppler spread is being measured and/or on the particular types of indoor and outdoor environments. Sub-signature S3 is shown as also being that measured values 18 of the Doppler spread are greater than or equal to the same upper threshold D_{U}, but in other embodiments not shown a different upper threshold may be used, such that the upper threshold used for the sub-signatures S1 and S3 may coincide or be different.

In any event, detecting the targeted signature SIG_{DS} in the example shown effectively amounts to detecting a meaningful, but temporary, drop in the Doppler spread. It is thereby this meaningful but temporary drop in Doppler spread that is indicative of the wireless communication device 12 making the transition 14 between indoor and outdoor environments 6, 8. Indeed, these embodiments may exploit the fact that making the transition 14 between environments 6, 8 typically involves maneuvering around or through some sort of obstacle (e.g., a door), a task that requires a slower speed of movement and thereby induces a temporary drop in Doppler spread. As shown in the example of FIG. 1, for instance, the wireless communication equipment 12, 16 may detect the targeted signature SIG_{DS} in the Doppler spread by detecting sub-signature S1 during the time period P1 before the transition 14 occurs, detecting sub-signature S2 during the time period P2 in which the transition 14 is occurring, and detecting sub-signature S3 during the time period P3 after the transition 14 has occurred.

Note though that the targeted signature SIG_{DS} shown in FIG. 1 is simplified for illustrative purposes. For example, the targeted signature SIG_{DS} shown assumes that the transition between sub-signatures S1 and S2 occurs instantaneously, and that the transition between sub-signatures S2 and S3 occurs instantaneously. In some embodiments, though, the targeted signature SIG_{DS} accounts for or includes a transition period between sub-signatures S1 and S2, as well as a transition period between sub-signatures S2 and S3, e.g., such that the transition between sub-signatures occurs more gradually overtime.

In other embodiments, the radio signal characteristics on which transition detection is based includes angular spread. Angular spread describes the spread in the angle of arrival of a signal transmitted through a multipath propagation channel. This angle of arrival may be characterized in the zenith/elevation domain and/or in the azimuth/horizontal domain.

In embodiments that exploit angular spread, the wireless communication equipment 12, 16 bases detection of the transition 14 on detection of a targeted signature over time in the angular spread (e.g., in a zenith domain) associated with the wireless communication device 12. In other words, the wireless communication equipment 12, 16 exploits changes over time in the angular spread as the wireless communication device 12 makes the transition 14 between environments 6, 8. The wireless communication equipment 12, 16 in this case pinpoints a particular change in the angular spread as being a signature of the transition's occurrence and/or timing. FIG. 1 shows an example of this as well.

In the example of FIG. 1, the wireless communication equipment 12, 16 alternatively or additionally bases detection of the transition 14 on detection of a targeted signature SIG_{AS} over time in the angular spread (e.g., in a zenith domain) associated with the wireless communication device 12. The wireless communication equipment 12, 16 in particular obtains measured values 20 of the angular spread as shown, and effectively compares those measured values 20 to the targeted signature SIG_{AS} in an attempt to identify the targeted signature SIG_{DS} in the measured values 20 of the angular spread. Such comparison of the measured values 20 and the targeted signature SIG_{AS} may involve for instance correlating the measured values 20 with the targeted signature SIG_{AS}. Note, too, that the measured values 20 on which the comparison is performed may be raw values or filtered values. Here, the filtered values may be formed by filtering the raw values in one or more ways, e.g., the filtered values may be time-averaged values of the angular spread. In these and other cases, filtering may aim to reduce noise in the raw values of angular spread. Note further that the comparison may account for a margin of error between the targeted signature SIG_{AS} and the measured values 20. Regardless, if the targeted signature SIG_{AS} is not found within the measured values 20 of the angular spread, the wireless communication equipment 12,16 deduces that the wireless communication device 12 has not made the transition 14 between indoor and outdoor environments 6, 8. But, if on the other hand the targeted signature SIG_{AS} is found within the measured values 20 of the angular spread, the wireless communication equipment 12,16 deduces that the wireless communication device 12 has indeed made the transition 14 between indoor and outdoor environments 6, 8. Moreover, in some embodiments, this comparison is performed iteratively as new measured values 20 of the angular spread are obtained (e.g., in real-time), such that the time at which the targeted signature SIG_{AS} is detected more or less corresponds with or otherwise indicates the time at which the wireless communication device 12 makes the transition 14 between environments 6, 8.

In some embodiments as shown, the targeted signature SIG_{AS} overtime in the angular spread comprises values of the angular spread changing by at least a threshold amount ΔAS over the course of a maximum time period ΔT. In this case, then, the targeted signature SIG_{AS} is detected when the measured values 20 of the angular spread change, in either direction, by at least the threshold amount ΔAS over the course of a time period that is less than or equal to the maximum time period ΔT. It is thereby this meaningful change in angular spread that is indicative of the wireless communication device 12 making the transition 14 between indoor and outdoor environments 6, 8.

Although the targeted signature SIG_{DS} in the Doppler spread and the targeted signature SIG_{AS} in angular spread were described separately above, the targeted signature whose detection is targeted may be a combination of the targeted signature SIG_{DS} in the Doppler spread and the targeted signature SIG_{AS} in angular spread. In this sense, detecting a targeted signature in the Doppler spread and the angular spread means detecting the combination of both the targeted signature SIG_{DS} in the Doppler spread and the targeted signature SIG_{AS} in angular spread, e.g., at the same time or within the same time window.

No matter the particular radio signal characteristics based on which the wireless communication equipment 12, 16 performs transition detection, the wireless communication equipment 12, 16 in some embodiments further determines whether the wireless communication equipment 12, 16 is in the outdoor environment 6 or the indoor environment 8 after the transition 14. That is, responsive to detecting the transition 14, the wireless communication equipment 12, 16 decides whether the transition 14 has resulted in the wireless communication device 12 being in the outdoor environment 6 or the indoor environment 8.

In some embodiments, the wireless communication equipment 12, 16 determines this based respectively on whether the wireless communication equipment 12, 16 detects a certain indoor signature or a certain outdoor signature over time, e.g., in the same or different radio signal characteristic(s) based on which the transition 14 was detected. That is, some embodiments pinpoint a particular signature over time as being a signature of the wireless communication device 12 being in the outdoor environment 6 and pinpoint another particular signature over time as being a signature of the wireless communication device 12 being in the indoor environment 8. The indoor and outdoor signatures may for instance be signatures over time in the Doppler spread or the angular spread associated with the wireless communication device 12.

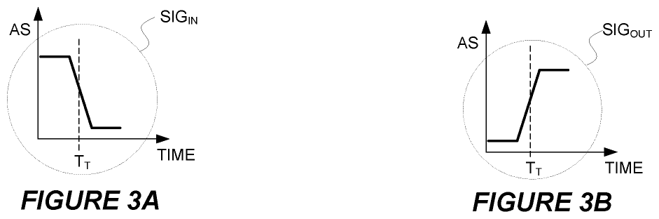

FIGS. 3A-3B show one example where the indoor and outdoor signatures are signatures over time in the angular spread. As shown in FIG. 3A, an indoor signature SIG_{IN} according to some embodiments comprises values of the angular spread being greater before the transition (e.g., at time T_{T}) than after the transition, e.g., by at least a threshold amount. And as shown in FIG. 3B, an outdoor signature SIG_{OUT} according to some embodiments comprises values of the angular spread being smaller before the transition (e.g., at time T_{T}) than after the transition, e.g., by at least a threshold amount. These embodiments may thereby exploit the fact that the angular spread, especially in the zenith or elevation domain, is different indoors than outdoors. Indeed, the angular spread will be higher when the wireless communication device 12 is in the outdoor environment 6 (e.g., due to the multipath components coming from various directions) than when the wireless communication device 12 is in the indoor environment 8. Accordingly, in one or more embodiments, responsive to the wireless communication equipment 12, 16 detecting the transition 14 at a certain time, the wireless communication equipment 12, 16 decides whether the transition 14 has resulted in the wireless communication device 12 being located in the outdoor environment 6 or the indoor environment 8 based respectively on whether the angular spread is greater or less than it was before the time of the transition 14.

That said, in some embodiments the wireless communication equipment 12, 16 makes the indoor/outdoor determination also based on one or more other criteria or radio signal characteristics. For example, in some embodiments, the wireless communication equipment 12, 16 makes the indoor/outdoor determination based further on whether a received signal power or quality for the wireless communication device 12 before the transition 14 is greater or less than a received signal power for the wireless communication device 12 after the transition 14. The received signal power may for instance be measured as a Reference Signal Received Power (RSRP) or Reference Signal Strength Indicator (RSSI), or as a received positioning signal power (e.g., Global Positioning Signal, GPS, power). Regardless, in one such embodiment, the wireless communication equipment 12, 16 determines that the transition 14 resulted in the wireless communication device 12 being located in the outdoor environment 6 if the received signal power after the transition 14 is greater than before the transition, but determines that the transition 14 resulted in the wireless communication device 12 being located in the indoor environment 8 if the received signal power after the transition 14 is less than before the transition, e.g., due to building penetration loss.

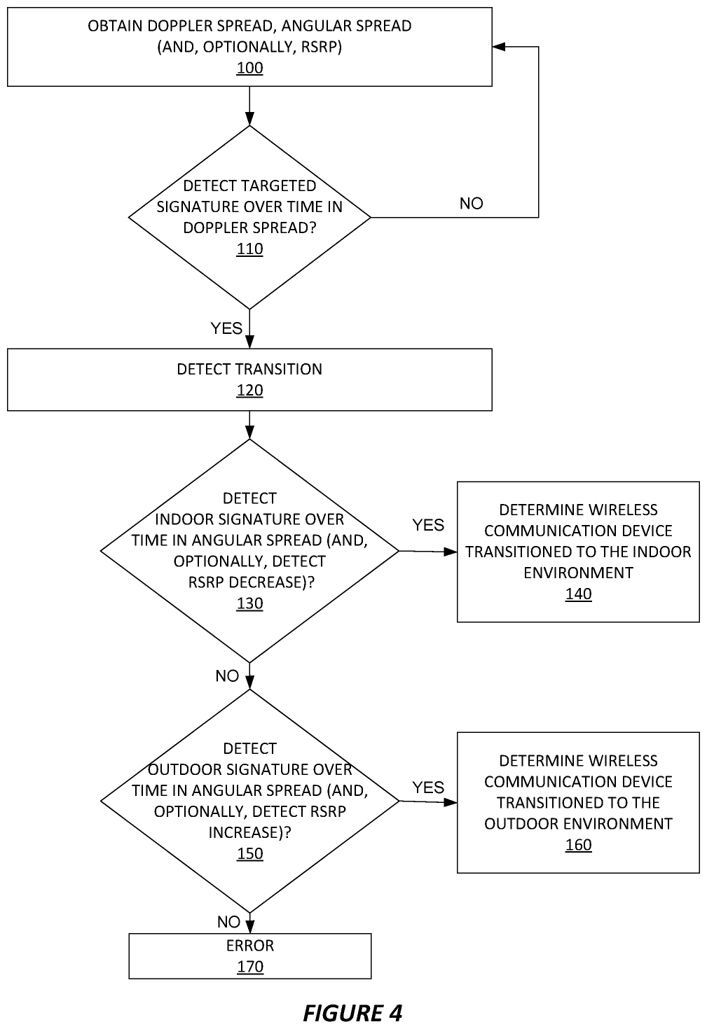

FIG. 4 illustrates the decision logic for the transition detection and indoor/outdoor determination according to some embodiments where the transition detection is based on Doppler spread and the indoor/outdoor determination is based on angular spread (and optionally RSRP). In these embodiments, then, the Doppler spread and the angular spread (in the zenith and/or azimuth domain(s)) are used together (optionally also with the RSRP) to decide whether and/or when the wireless communication device 12 makes a transition 14 between indoor and outdoor environments 6, 8, as well as to decide which environment 6, 8 the wireless communication device 12 ended up in due to the transition 14.

As shown, the wireless communication equipment 12, 16 obtains (e.g., at regular time intervals) the Doppler spread and angular spread associated with the wireless communication equipment 12 (Block 100). The wireless communication equipment 12, 16 may for instance obtain measured values 18 of the Doppler spread and measured values 20 of the angular spread. If the wireless communication equipment 12, 16 is the wireless communication device 12 itself, this obtaining may involve actually measuring the Doppler spread, angular spread, and/or RSRP over time on one or more signals received by the wireless communication device 12, e.g., by measuring a received reference signal such as a Channel State Information Reference Signal (CSI-RS) or a cell-specific reference signal (CRS). Or, if the wireless communication equipment 12, 16 is a network node 16, this obtaining may involve receiving, from the wireless communication device 12, one or more measurement reports that report the Doppler spread, angular spread, and/or RSRP as measured by the wireless communication device 12 over time on one or more signals received by the wireless communication device 12. Or, in other embodiments where the wireless communication equipment 12, 16 is a network node 16, this obtaining may involve the network node 16 itself actually measuring the Doppler spread, angular spread, and/or RSRP over time on one or more signals received by the network node 16 from the wireless communication device 12, e.g., by measuring a reference signal such as a Sounding Reference Signal (SRS) received from the wireless communication device 12.

Regardless, the wireless communication equipment 12, 16 then attempts to detect the targeted signature SIG_{DS} over time in the Doppler spread, e.g., by comparing the targeted signatured SIG_{DS} to the measured values 18 of the Doppler spread that were obtained (Block 110). In one example, attempting to detect the targeted signature SIG_{DS} involves checking if the Doppler spread drops below a lower threshold (e.g., so as to drop close to zero) for n time intervals. No matter the particular targeted signature SIG_{DS}, though, if the targeted signature SIG_{DS} is not detected (NO at Block 110), the wireless communication equipment 12, 16 re-obtains the Doppler spread and angular spread associated with the wireless communication device 12, e.g., at the next time interval (Block 100). On the other hand, if the targeted signature SIG_{DS} is detected (YES at Block 110), the wireless communication equipment 12, 16 detects the transition 14 as having occurred (Block 120).

Responsive to detecting the transition 14 as having occurred, the wireless communication equipment 12, 16 then makes a determination as to whether the transition 14 was to the indoor environment 8 or the outdoor environment 6. In this regard, the wireless communication equipment 12, 16 attempts to detect the indoor signature SIG_{IN} over time in the angular spread (e.g., in the zenith domain) associated with the wireless communication device (Block 130). This may involve, for example, detecting if the time-averaged angular spread before the transition 14 is greater than the time-averaged angular spread after the transition 14. In some embodiments, the wireless communication equipment 12, 16 may additionally attempt to detect a decrease in the RSRP associated with the wireless communication device 12, e.g., by detecting if the time-averaged RSRP before the transition 14 was greater than the time-averaged RSRP after the transition 14. If the indoor signature is detected (and optionally if an RSRP decrease is detected) (YES at Block 130), then the wireless communication equipment 12, 16 determines that the wireless communication device 12 transitioned to the indoor environment 8 (Block 140). Otherwise (NO at Block 130), the wireless communication equipment 12, 16 attempts to detect the outdoor signature SIG_{OUT} over time in the angular spread (e.g., in the zenith domain) associated with the wireless communication device (Block 150). This may involve, for example, detecting if the time-averaged angular spread before the transition 14 is less than or equal to the time-averaged angular spread after the transition 14. In some embodiments, the wireless communication equipment 12, 16 may additionally attempt to detect an increase in the RSRP associated with the wireless communication device 12, e.g., by detecting if the time-averaged RSRP before the transition 14 was less than the time-averaged RSRP after the transition 14. If the outdoor signature is detected (and optionally if an RSRP increase is detected) (YES at Block 150), then the wireless communication equipment 12, 16 determines that the wireless communication device 12 transitioned to the outdoor environment 6 (Block 160). Otherwise, an error is detected (Block 170).

By providing for the detection of the transition 14 by the wireless communication device 12 between outdoor and indoor environments 6, 8, some embodiments herein enable the wireless communication equipment 12, 16 to perform any number of actions based on such transition detection. In some embodiments, for example, based on detecting the transition 14, the wireless communication equipment 12, 16 adapts one or more parameters that govern wireless communication to and/or from the wireless communication device 12. The one or more parameters may include for instance a channelization coding rate, a modulation scheme, a transmission rank, a precoder, beamforming, or any other parameter at a physical layer, medium access control layer, or radio resource control layer. The one or more parameters may alternatively or additionally include a parameter that controls how often beam sweeping is performed targeting the wireless communication device 12, e.g., since the transition detection gives an indication of how stationary the spatial directions are at the wireless communication device 12. Alternatively or additionally, in other embodiments, based on detecting the transition 14, the wireless communication equipment 12, 16 adjusts resources allocated to the wireless communication device 14. Such resources may include for instance radio resources and/or processing resources. Alternatively or additionally, the wireless communication equipment 12, 16 performs user behavior contextualization and/or user behavior learning based on detecting the transition 14, e.g., to learn the timing and frequency with which such transitions typically occur for the wireless communication device 12.

In yet other embodiments, based on detecting the transition 14, the wireless communication equipment 12, 16 triggers a decision about whether to hand over the wireless communication device 12 between network nodes or beams. Indeed, the transition 14 and the accompanying change in radio environment suggests that the network node (e.g., base station) or beam providing the best radio coverage to the wireless communication device 12 may very well change. Some embodiments thereby exploit detection of the transition 14 as a triggering event for a handover decision, e.g., so as to proactively initiate the handover decision in a more timely manner rather than waiting to initiate the decision only in response to deteriorating radio conditions. For example, rather than waiting to initiate a handover decision only once radio conditions deteriorate in the indoor environment 8, some embodiments initiate the handover decision earlier by initiating the handover decision proactively upon occurrence of the transition 14 to the indoor environment 8. When the wireless communication device 12 is detected as transitioning from the outdoor environment 6 to the indoor environment 8, for instance, the wireless communication equipment 12, 16 may initiate a handover of the wireless communication device 12 from a radio network node 4 deployed in the outdoor environment 6 (e.g., an outdoor base station or outdoor cell) to a radio network node 4 deployed in the indoor environment 8 (e.g., an indoor access point or indoor cell). In some cases, then, triggering a handover decision based on detection of the transition 14 may advantageously improve handover success rates and radio performance for the wireless communication device 12. As these examples demonstrate, then, basing these and other types of actions on detection of the transition 14 between environments 6, 8 may advantageously improve system performance, device performance, and/or quality of experience (QoE) and quality of service (QoS).

Note that, in embodiments where the wireless communication equipment 12, 16 performing the transition detection is network node 16, such network node 16 may be any node in the wireless communication network 2, whether in the access network of the wireless communication network 2 or the core network of the wireless communication network 2. In one particular embodiment, though, the network node 16 is a radio network node serving the wireless communication device 12.

Note also that, although illustrated as being an environment inside a building 10 or other enclosure, the indoor environment 8 is not limited to this example. Nor is an outdoor environment 6 limited to being an environment outside of a building 10 or other enclosure. In other embodiments, for example, an indoor environment 8 is any environment that has some type of roof (irrespective of whether the environment has any walls), whereas an outdoor environment 6 is an environment that lacks any type of roof. In these and other embodiments, then a parking garage or tunnel is another example of an indoor environment 8 where that parking garage and tunnel each have some sort of roof. And, in this particular example, the wireless communication device 12 may be exemplified as being integrated within a vehicle capable of wireless communication or as being within a vehicle. The wireless communication device 12 may then make a transition 14 from outdoor environment 6 to indoor environment 8 when the vehicle enters the parking garage or tunnel.

Note, too, that persons of ordinary skill in the art will appreciate that reliability of indoor/outdoor classification (or detection of transitions between indoor and outdoor environments) may be improved by combining the disclosed embodiments with additional techniques (and/or additional patterns in measured quantities) for detecting whether a wireless communication device is indoors or outdoors.

Note further that ways to measure Doppler spread and angular spread are known in the art. The person of ordinary skill in the art knows how such measurements may be implemented. A network node (such as a base station) may have better (more advanced, and/or larger and/or more expensive and/or more power consuming) equipment/components for making such measurements than a wireless communication device (such as a UE). Since a network node (such as a base station) is typically stationary with a fixed orientation (in contrast to a wireless communication device such as a UE for which the orientation may be unknown) the network node may be better suited to measure angular spread in the zenith domain.

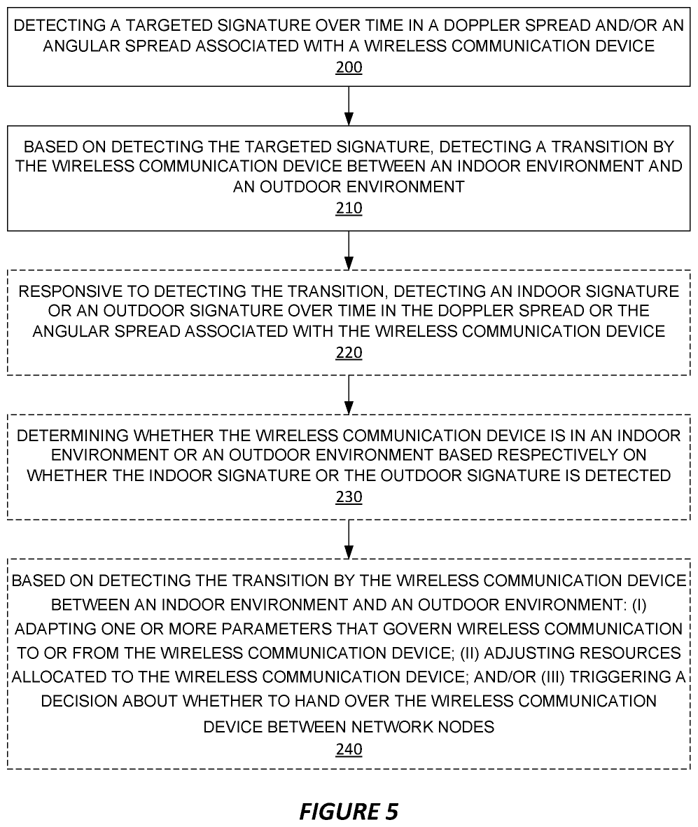

In view of the modifications and variations herein, FIG. 5 depicts a method in accordance with particular embodiments. The method may be performed by wireless communication equipment 12, 16. The method includes detecting a targeted signature over time in a Doppler spread and/or an angular spread associated with a wireless communication device 12 (Block 200). The method further includes, based on detecting the targeted signature, detecting a transition 14 by the wireless communication device 12 between an indoor environment 8 and an outdoor environment 6 (Block 210).

In some embodiments where the detecting comprises detecting a targeted signature over time in a Doppler spread associated with the wireless communication device 12, detecting the targeted signature over time in the Doppler spread may comprise detecting a first sub-signature S1 in the Doppler spread during a first time period, detecting a second sub-signature S2 in the Doppler spread during a second time period after the first time period, and detecting a third sub-signature S3 in the Doppler spread during a third time period after the second time period. Here, the first, second, and third sub-signatures are sub-signatures of the targeted signature. In one embodiment, for example, the first sub-signature S1 in the Doppler spread is values 18 of the Doppler spread being greater than or equal to a first upper threshold, the second sub-signature S2 in the Doppler spread is values 18 of the Doppler spread being less than or equal to a lower threshold, and the third sub-signature S3 in the Doppler spread is values 18 of the Doppler spread being greater than or equal to a second upper threshold, where the first and second upper thresholds coincide or are different. In one example, the lower threshold is less than or equal to 20% of the first upper threshold or the second upper threshold. Alternatively or additionally, the values 18 of the Doppler spread may be time-averaged values of the Doppler spread.

In other embodiments where the detecting alternatively or additionally comprises detecting a targeted signature over time in an angular spread (e.g., in a zenith domain) associated with the wireless communication device 12, the targeted signature over time in the angular spread may comprise values 20 of the angular spread changing by at least a threshold amount over the course of a maximum time period. In one example, the values 20 of the angular spread are time-averaged values of the angular spread.

In some embodiments, the method further comprises, responsive to detecting the transition 14, detecting an indoor signature SIG_{IN} or an outdoor signature SIG_{OUT} over time in the Doppler spread or the angular spread associated with the wireless communication device 12 (Block 220). In this case, the method may further comprises determining whether the wireless communication device 12 is in an indoor environment 8 or an outdoor environment 6 based respectively on whether the indoor signature SIG_{IN} or the outdoor signature SIG_{OUT} is detected (Block 230). In one example, the indoor signature SIG_{IN} comprises values of the angular spread being greater before the transition 14 than after the transition 14, and the outdoor signature SIG_{OUT} comprises values of the angular spread being smaller before the transition 14 than after the transition 14. Alternatively or additionally, in some embodiments, determining whether the wireless communication device 12 is in an indoor environment 8 or an outdoor environment 6 is based further on whether a received signal power for the wireless communication device 12 before the transition 14 is greater or less than a received signal power for the wireless communication device 12 after the transition 14.

In some embodiments, the method is performed by a network node 16 in a wireless communication network 2 serving the wireless communication device 12. In one such embodiment, the method may further comprise receiving, from the wireless communication device 12, one or more measurement reports that report the Doppler spread and/or the angular spread as measured by the wireless communication device 12 over time on one or more signals received by the wireless communication device 12. In another such embodiment, though, the method may further comprise measuring the Doppler spread and/or the angular spread over time on one or more signals received by the network node 16 from the wireless communication device 12.

In other embodiments, the method may be performed by the wireless communication device 12. In this case, the method may further comprise measuring the Doppler spread and/or the angular spread over time on one or more signals received by the wireless communication device 12. Alternatively or additionally, the method may further comprise reporting, to a network node 16, the occurrence of the detected transition 14 and/or a presence of the wireless communication device 12 in the indoor environment 8 or the outdoor environment 6.

Alternatively or additionally, in some embodiments, the method further comprises, based on detecting the transition 14 by the wireless communication device 12 between an indoor environment 8 and an outdoor environment 6, (i) adapting one or more parameters that govern wireless communication to or from the wireless communication device 12; (ii) adjusting resources allocated to the wireless communication device 12; and/or (iii) triggering a decision about whether to hand over the wireless communication device 12 between network nodes.

In some embodiments, the angular spread includes angular spread in a zenith domain.

In some embodiments, an indoor environment 8 has some type of roof and an outdoor environment 6 lacks any type of roof. In other embodiments, an indoor environment 8 is inside a building, and an outdoor environment 6 is outside a building, where a building has a roof and walls.

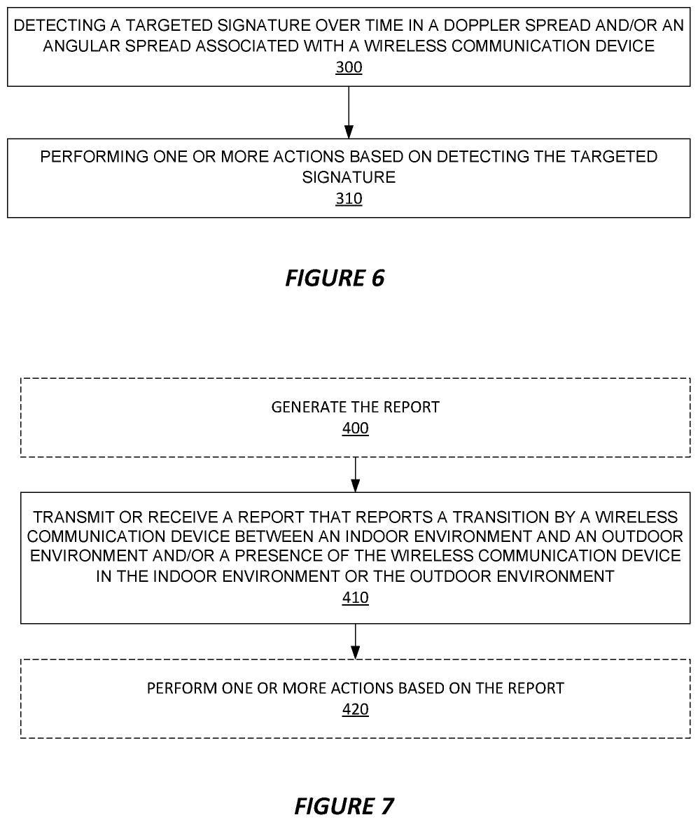

FIG. 6 depicts a method in accordance with other particular embodiments. The method includes detecting a targeted signature over time in a Doppler spread and/or an angular spread associated with a wireless communication device 12 (Block 300). The method further includes performing one or more actions based on detecting the targeted signature (Block 310). In some embodiments, the one or more actions include one or more of: (i) triggering a decision about whether to hand over the wireless communication device between a network node associated with an indoor environment and a network node associated with an outdoor environment; (ii) adapting one or more parameters that govern wireless communication to or from the wireless communication device 12; (iii) adjusting resources allocated to the wireless communication device 12; and/or (iv) triggering a decision about whether to hand over the wireless communication device 12 between network nodes.

In some embodiments where the detecting comprises detecting a targeted signature over time in a Doppler spread associated with the wireless communication device 12, detecting the targeted signature over time in the Doppler spread may comprise detecting a first sub-signature S1 in the Doppler spread during a first time period, detecting a second sub-signature S2 in the Doppler spread during a second time period after the first time period, and detecting a third sub-signature S3 in the Doppler spread during a third time period after the second time period. Here, the first, second, and third sub-signatures are sub-signatures of the targeted signature SIG_{D}S. In one embodiment, for example, the first sub-signature S1 in the Doppler spread is values 18 of the Doppler spread being greater than or equal to a first upper threshold, the second sub-signature S2 in the Doppler spread is values 18 of the Doppler spread being less than or equal to a lower threshold, and the third sub-signature S3 in the Doppler spread is values 18 of the Doppler spread being greater than or equal to a second upper threshold, where the first and second upper thresholds coincide or are different. In one example, the lower threshold is less than or equal to 20% of the first upper threshold or the second upper threshold. Alternatively or additionally, the values 18 of the Doppler spread may be time-averaged values of the Doppler spread.

In other embodiments where the detecting alternatively or additionally comprises detecting a targeted signature over time in an angular spread (e.g., in a zenith domain) associated with the wireless communication device 12, the targeted signature over time in the angular spread may comprise values 20 of the angular spread changing by at least a threshold amount over the course of a maximum time period. In one example, the values 20 of the angular spread are time-averaged values of the angular spread.

In some embodiments, the method is performed by a network node 16 in a wireless communication network 2 serving the wireless communication device 12. In one such embodiment, the method may further comprise receiving, from the wireless communication device 12, one or more measurement reports that report the Doppler spread and/or the angular spread as measured by the wireless communication device 12 over time on one or more signals received by the wireless communication device 12. In another such embodiment, though, the method may further comprise measuring the Doppler spread and/or the angular spread over time on one or more signals received by the network node 16 from the wireless communication device 12.

In other embodiments, the method may be performed by the wireless communication device 12. In this case, the method may further comprise measuring the Doppler spread and/or the angular spread over time on one or more signals received by the wireless communication device 12.

In some embodiments, the angular spread includes angular spread in a zenith domain.

FIG. 7 depicts a method in accordance with yet other embodiments. The method may be implemented by wireless communication equipment 12, 16. The method as shown includes transmitting or receiving a report that reports a transition 14 by a wireless communication device 12 between an indoor environment 8 and an outdoor environment 6 and/or a presence of the wireless communication device 12 in the indoor environment 8 or the outdoor environment 6 (Block 410). In case the wireless communication equipment 12, 16 performing the method is the wireless communication device 12, the method may further include generating the report (Block 400). The report may for example be generated based on Doppler spread and/or angular spread, as described above with reference to FIGS. 1-5. On the other hand, in case the wireless communication equipment 12, 16 performing the method is a network node 16, the method may also include performing one or more actions (such as one or more of the actions in Block 240 in the method described above with reference to FIG. 5) based on the report, e.g., as described above.

In some embodiments, the angular spread includes angular spread in a zenith domain.

In some embodiments, an indoor environment 8 has some type of roof and an outdoor environment 6 lacks any type of roof. In other embodiments, an indoor environment 8 is inside a building, and an outdoor environment 6 is outside a building, where a building has a roof and walls.

Embodiments herein also include corresponding apparatuses. Embodiments herein for instance include wireless communication equipment 12, 16 configured to perform any of the steps of any of the embodiments described above for the wireless communication equipment 12, 16.

Embodiments also include wireless communication equipment 12, 16 comprising processing circuitry and power supply circuitry. The processing circuitry is configured to perform any of the steps of any of the embodiments described above for the wireless communication equipment 12, 16. The power supply circuitry is configured to supply power to the wireless communication equipment 12, 16.

Embodiments further include wireless communication equipment 12, 16 comprising processing circuitry. The processing circuitry is configured to perform any of the steps of any of the embodiments described above for the wireless communication equipment 12, 16. In some embodiments, the wireless communication equipment 12, 16 further comprises communication circuitry.

Embodiments further include wireless communication equipment 12, 16 comprising processing circuitry and memory. The memory contains instructions executable by the processing circuitry whereby the wireless communication equipment 12, 16 is configured to perform any of the steps of any of the embodiments described above for the wireless communication equipment 12, 16.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication equipment 12, 16. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

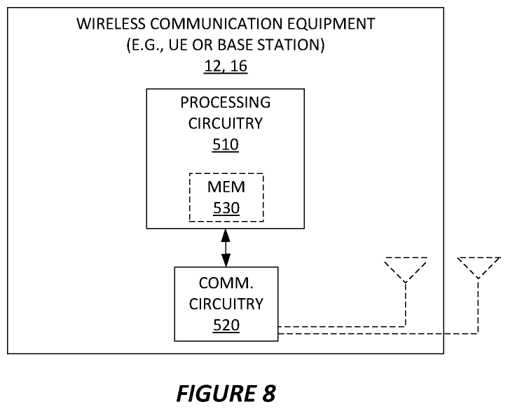

FIG. 8 for example illustrates wireless communication equipment 12, 16 as implemented in accordance with one or more embodiments. In some embodiments, wireless communication equipment 12, 16 is the wireless communication device 12. In other embodiments, wireless communication equipment 12, 16 is the network node 16, e.g., configured to serve the wireless communication device 12. Regardless, as shown, the wireless communication equipment 12, 16 includes processing circuitry 510 and communication circuitry 520. The communication circuitry 520 (e.g., radio circuitry) is configured to transmit and/or receive information to and/or from one or more other nodes, e.g., via any communication technology. Such communication may occur via one or more antennas that are either internal or external to the wireless communication equipment 12, 16. The processing circuitry 510 is configured to perform processing described above, e.g., in any of FIGS. 5, 6 and 7, such as by executing instructions stored in memory 530. The processing circuitry 510 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

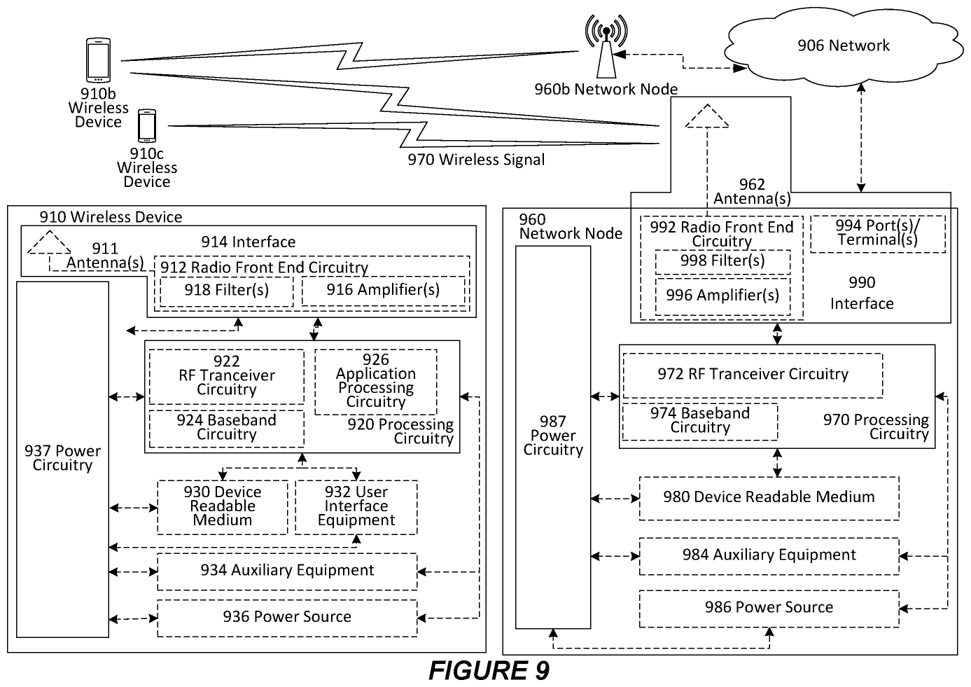

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 906, network nodes 960 and 960b, and WDs 910, 910b, and 910c. In practice, a wireless network may further include any additional elements suitable to support communication between wireless devices or between a wireless device and another communication device, such as a landline telephone, a service provider, or any other network node or end device. Of the illustrated components, network node 960 and wireless device (WD) 910 are depicted with additional detail. The wireless network may provide communication and other types of services to one or more wireless devices to facilitate the wireless devices' access to and/or use of the services provided by, or via, the wireless network.

Note that the wireless communication device 12 in FIG. 1 herein may correspond to any of WDs 910, 910b, and 910c in FIG. 9. The network node 16 in FIG. 1 herein may correspond to any of network nodes 960 or 960b in FIG. 9. Accordingly, the wireless communication equipment 12, 16 in FIG. 1 may correspond to any of WDs 910, 910b, 910c or to any of network nodes 960 or 960b in FIG. 9.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 906 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 960 and WD 910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 960 includes processing circuitry 970, device readable medium 980, interface 990, auxiliary equipment 984, power source 986, power circuitry 987, and antenna 962. Although network node 960 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 960 are depicted as single boxes located within a larger box, or nested within multiple boxes, in practice, a network node may comprise multiple different physical components that make up a single illustrated component (e.g., device readable medium 980 may comprise multiple separate hard drives as well as multiple RAM modules).

Similarly, network node 960 may be composed of multiple physically separate components (e.g., a NodeB component and a RNC component, or a BTS component and a BSC component, etc.), which may each have their own respective components. In certain scenarios in which network node 960 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 960 may be configured to support multiple radio access technologies (RATs). In such embodiments, some components may be duplicated (e.g., separate device readable medium 980 for the different RATs) and some components may be reused (e.g., the same antenna 962 may be shared by the RATs). Network node 960 may also include multiple sets of the various illustrated components for different wireless technologies integrated into network node 960, such as, for example, GSM, WCDMA, LTE, NR, WiFi, or Bluetooth wireless technologies. These wireless technologies may be integrated into the same or different chip or set of chips and other components within network node 960.

Processing circuitry 970 is configured to perform any determining, calculating, or similar operations (e.g., certain obtaining operations) described herein as being provided by a network node. These operations performed by processing circuitry 970 may include processing information obtained by processing circuitry 970 by, for example, converting the obtained information into other information, comparing the obtained information or converted information to information stored in the network node, and/or performing one or more operations based on the obtained information or converted information, and as a result of said processing making a determination.

Processing circuitry 970 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 960 components, such as device readable medium 980, network node 960 functionality. For example, processing circuitry 970 may execute instructions stored in device readable medium 980 or in memory within processing circuitry 970. Such functionality may include providing any of the various wireless features, functions, or benefits discussed herein. In some embodiments, processing circuitry 970 may include a system on a chip (SOC).

In some embodiments, processing circuitry 970 may include one or more of radio frequency (RF) transceiver circuitry 972 and baseband processing circuitry 974. In some embodiments, radio frequency (RF) transceiver circuitry 972 and baseband processing circuitry 974 may be on separate chips (or sets of chips), boards, or units, such as radio units and digital units. In alternative embodiments, part or all of RF transceiver circuitry 972 and baseband processing circuitry 974 may be on the same chip or set of chips, boards, or units

In certain embodiments, some or all of the functionality described herein as being provided by a network node, base station, eNB or other such network device may be performed by processing circuitry 970 executing instructions stored on device readable medium 980 or memory within processing circuitry 970. In alternative embodiments, some or all of the functionality may be provided by processing circuitry 970 without executing instructions stored on a separate or discrete device readable medium, such as in a hard-wired manner. In any of those embodiments, whether executing instructions stored on a device readable storage medium or not, processing circuitry 970 can be configured to perform the described functionality. The benefits provided by such functionality are not limited to processing circuitry 970 alone or to other components of network node 960, but are enjoyed by network node 960 as a whole, and/or by end users and the wireless network generally.

Device readable medium 980 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 970. Device readable medium 980 may store any suitable instructions, data or information, including a computer program, software, an application including one or more of logic, rules, code, tables, etc. and/or other instructions capable of being executed by processing circuitry 970 and, utilized by network node 960. Device readable medium 980 may be used to store any calculations made by processing circuitry 970 and/or any data received via interface 990. In some embodiments, processing circuitry 970 and device readable medium 980 may be considered to be integrated.

Interface 990 is used in the wired or wireless communication of signalling and/or data between network node 960, network 906, and/or WDs 910. As illustrated, interface 990 comprises port(s)/terminal(s) 994 to send and receive data, for example to and from network 906 over a wired connection. Interface 990 also includes radio front end circuitry 992 that may be coupled to, or in certain embodiments a part of, antenna 962. Radio front end circuitry 992 comprises filters 998 and amplifiers 996. Radio front end circuitry 992 may be connected to antenna 962 and processing circuitry 970. Radio front end circuitry may be configured to condition signals communicated between antenna 962 and processing circuitry 970. Radio front end circuitry 992 may receive digital data that is to be sent out to other network nodes or WDs via a wireless connection. Radio front end circuitry 992 may convert the digital data into a radio signal having the appropriate channel and bandwidth parameters using a combination of filters 998 and/or amplifiers 996. The radio signal may then be transmitted via antenna 962. Similarly, when receiving data, antenna 962 may collect radio signals which are then converted into digital data by radio front end circuitry 992. The digital data may be passed to processing circuitry 970. In other embodiments, the interface may comprise different components and/or different combinations of components.

In certain alternative embodiments, network node 960 may not include separate radio front end circuitry 992, instead, processing circuitry 970 may comprise radio front end circuitry and may be connected to antenna 962 without separate radio front end circuitry 992. Similarly, in some embodiments, all or some of RF transceiver circuitry 972 may be considered a part of interface 990. In still other embodiments, interface 990 may include one or more ports or terminals 994, radio front end circuitry 992, and RF transceiver circuitry 972, as part of a radio unit (not shown), and interface 990 may communicate with baseband processing circuitry 974, which is part of a digital unit (not shown).

Antenna 962 may include one or more antennas, or antenna arrays, configured to send and/or receive wireless signals. Antenna 962 may be coupled to radio front end circuitry 990 and may be any type of antenna capable of transmitting and receiving data and/or signals wirelessly. In some embodiments, antenna 962 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 962 may be separate from network node 960 and may be connectable to network node 960 through an interface or port.

Antenna 962, interface 990, and/or processing circuitry 970 may be configured to perform any receiving operations and/or certain obtaining operations described herein as being performed by a network node. Any information, data and/or signals may be received from a wireless device, another network node and/or any other network equipment. Similarly, antenna 962, interface 990, and/or processing circuitry 970 may be configured to perform any transmitting operations described herein as being performed by a network node. Any information, data and/or signals may be transmitted to a wireless device, another network node and/or any other network equipment.

Power circuitry 987 may comprise, or be coupled to, power management circuitry and is configured to supply the components of network node 960 with power for performing the functionality described herein. Power circuitry 987 may receive power from power source 986. Power source 986 and/or power circuitry 987 may be configured to provide power to the various components of network node 960 in a form suitable for the respective components (e.g., at a voltage and current level needed for each respective component). Power source 986 may either be included in, or external to, power circuitry 987 and/or network node 960. For example, network node 960 may be connectable to an external power source (e.g., an electricity outlet) via an input circuitry or interface such as an electrical cable, whereby the external power source supplies power to power circuitry 987. As a further example, power source 986 may comprise a source of power in the form of a battery or battery pack which is connected to, or integrated in, power circuitry 987. The battery may provide backup power should the external power source fail. Other types of power sources, such as photovoltaic devices, may also be used.

Alternative embodiments of network node 960 may include additional components beyond those shown in FIG. 9 that may be responsible for providing certain aspects of the network node's functionality, including any of the functionality described herein and/or any functionality necessary to support the subject matter described herein. For example, network node 960 may include user interface equipment to allow input of information into network node 960 and to allow output of information from network node 960. This may allow a user to perform diagnostic, maintenance, repair, and other administrative functions for network node 960.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 910 includes antenna 911, interface 914, processing circuitry 920, device readable medium 930, user interface equipment 932, auxiliary equipment 934, power source 936 and power circuitry 937. WD 910 may include multiple sets of one or more of the illustrated components for different wireless technologies supported by WD 910, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 910.

Antenna 911 may include one or more antennas or antenna arrays, configured to send and/or receive wireless signals, and is connected to interface 914. In certain alternative embodiments, antenna 911 may be separate from WD 910 and be connectable to WD 910 through an interface or port. Antenna 911, interface 914, and/or processing circuitry 920 may be configured to perform any receiving or transmitting operations described herein as being performed by a WD. Any information, data and/or signals may be received from a network node and/or another WD. In some embodiments, radio front end circuitry and/or antenna 911 may be considered an interface.

As illustrated, interface 914 comprises radio front end circuitry 912 and antenna 911. Radio front end circuitry 912 comprise one or more filters 918 and amplifiers 916. Radio front end circuitry 914 is connected to antenna 911 and processing circuitry 920, and is configured to condition signals communicated between antenna 911 and processing circuitry 920. Radio front end circuitry 912 may be coupled to or a part of antenna 911. In some embodiments, WD 910 may not include separate radio front end circuitry 912; rather, processing circuitry 920 may comprise radio front end circuitry and may be connected to antenna 911. Similarly, in some embodiments, some or all of RF transceiver circuitry 922 may be considered a part of interface 914. Radio front end circuitry 912 may receive digital data that is to be sent out to other network nodes or WDs via a wireless connection. Radio front end circuitry 912 may convert the digital data into a radio signal having the appropriate channel and bandwidth parameters using a combination of filters 918 and/or amplifiers 916. The radio signal may then be transmitted via antenna 911. Similarly, when receiving data, antenna 911 may collect radio signals which are then converted into digital data by radio front end circuitry 912. The digital data may be passed to processing circuitry 920. In other embodiments, the interface may comprise different components and/or different combinations of components.

Processing circuitry 920 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 910 components, such as device readable medium 930, WD 910 functionality. Such functionality may include providing any of the various wireless features or benefits discussed herein. For example, processing circuitry 920 may execute instructions stored in device readable medium 930 or in memory within processing circuitry 920 to provide the functionality disclosed herein.

As illustrated, processing circuitry 920 includes one or more of RF transceiver circuitry 922, baseband processing circuitry 924, and application processing circuitry 926. In other embodiments, the processing circuitry may comprise different components and/or different combinations of components. In certain embodiments processing circuitry 920 of WD 910 may comprise a SOC. In some embodiments, RF transceiver circuitry 922, baseband processing circuitry 924, and application processing circuitry 926 may be on separate chips or sets of chips. In alternative embodiments, part or all of baseband processing circuitry 924 and application processing circuitry 926 may be combined into one chip or set of chips, and RF transceiver circuitry 922 may be on a separate chip or set of chips. In still alternative embodiments, part or all of RF transceiver circuitry 922 and baseband processing circuitry 924 may be on the same chip or set of chips, and application processing circuitry 926 may be on a separate chip or set of chips. In yet other alternative embodiments, part or all of RF transceiver circuitry 922, baseband processing circuitry 924, and application processing circuitry 926 may be combined in the same chip or set of chips. In some embodiments, RF transceiver circuitry 922 may be a part of interface 914. RF transceiver circuitry 922 may condition RF signals for processing circuitry 920.

In certain embodiments, some or all of the functionality described herein as being performed by a WD may be provided by processing circuitry 920 executing instructions stored on device readable medium 930, which in certain embodiments may be a computer-readable storage medium. In alternative embodiments, some or all of the functionality may be provided by processing circuitry 920 without executing instructions stored on a separate or discrete device readable storage medium, such as in a hard-wired manner. In any of those particular embodiments, whether executing instructions stored on a device readable storage medium or not, processing circuitry 920 can be configured to perform the described functionality. The benefits provided by such functionality are not limited to processing circuitry 920 alone or to other components of WD 910, but are enjoyed by WD 910 as a whole, and/or by end users and the wireless network generally.

Processing circuitry 920 may be configured to perform any determining, calculating, or similar operations (e.g., certain obtaining operations) described herein as being performed by a WD. These operations, as performed by processing circuitry 920, may include processing information obtained by processing circuitry 920 by, for example, converting the obtained information into other information, comparing the obtained information or converted information to information stored by WD 910, and/or performing one or more operations based on the obtained information or converted information, and as a result of said processing making a determination.

Device readable medium 930 may be operable to store a computer program, software, an application including one or more of logic, rules, code, tables, etc. and/or other instructions capable of being executed by processing circuitry 920. Device readable medium 930 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 920. In some embodiments, processing circuitry 920 and device readable medium 930 may be considered to be integrated.

User interface equipment 932 may provide components that allow for a human user to interact with WD 910. Such interaction may be of many forms, such as visual, audial, tactile, etc. User interface equipment 932 may be operable to produce output to the user and to allow the user to provide input to WD 910. The type of interaction may vary depending on the type of user interface equipment 932 installed in WD 910. For example, if WD 910 is a smart phone, the interaction may be via a touch screen; if WD 910 is a smart meter, the interaction may be through a screen that provides usage (e.g., the number of gallons used) or a speaker that provides an audible alert (e.g., if smoke is detected). User interface equipment 932 may include input interfaces, devices and circuits, and output interfaces, devices and circuits. User interface equipment 932 is configured to allow input of information into WD 910, and is connected to processing circuitry 920 to allow processing circuitry 920 to process the input information. User interface equipment 932 may include, for example, a microphone, a proximity or other sensor, keys/buttons, a touch display, one or more cameras, a USB port, or other input circuitry. User interface equipment 932 is also configured to allow output of information from WD 910, and to allow processing circuitry 920 to output information from WD 910. User interface equipment 932 may include, for example, a speaker, a display, vibrating circuitry, a USB port, a headphone interface, or other output circuitry. Using one or more input and output interfaces, devices, and circuits, of user interface equipment 932, WD 910 may communicate with end users and/or the wireless network, and allow them to benefit from the functionality described herein.

Auxiliary equipment 934 is operable to provide more specific functionality which may not be generally performed by WDs. This may comprise specialized sensors for doing measurements for various purposes, interfaces for additional types of communication such as wired communications etc. The inclusion and type of components of auxiliary equipment 934 may vary depending on the embodiment and/or scenario.

Power source 936 may, in some embodiments, be in the form of a battery or battery pack. Other types of power sources, such as an external power source (e.g., an electricity outlet), photovoltaic devices or power cells, may also be used. WD 910 may further comprise power circuitry 937 for delivering power from power source 936 to the various parts of WD 910 which need power from power source 936 to carry out any functionality described or indicated herein. Power circuitry 937 may in certain embodiments comprise power management circuitry. Power circuitry 937 may additionally or alternatively be operable to receive power from an external power source; in which case WD 910 may be connectable to the external power source (such as an electricity outlet) via input circuitry or an interface such as an electrical power cable. Power circuitry 937 may also in certain embodiments be operable to deliver power from an external power source to power source 936. This may be, for example, for the charging of power source 936. Power circuitry 937 may perform any formatting, converting, or other modification to the power from power source 936 to make the power suitable for the respective components of WD 910 to which power is supplied.

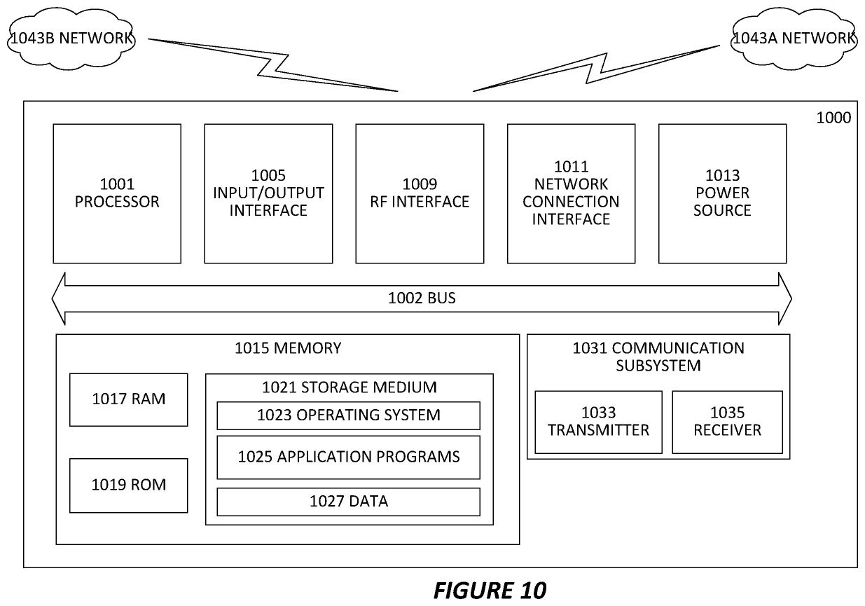

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 10200 may be any UE identified by the 3^{rd} Generation Partnership Project (3GPP), including a NB-IoT UE, a machine type communication (MTC) UE, and/or an enhanced MTC (eMTC) UE. UE 1000, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1000 includes processing circuitry 1001 that is operatively coupled to input/output interface 1005, radio frequency (RF) interface 1009, network connection interface 1011, memory 1015 including random access memory (RAM) 1017, read-only memory (ROM) 1019, and storage medium 1021 or the like, communication subsystem 1031, power source 1033, and/or any other component, or any combination thereof. Storage medium 1021 includes operating system 1023, application program 1025, and data 1027. In other embodiments, storage medium 1021 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1001 may be configured to process computer instructions and data. Processing circuitry 1001 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1001 may include two central processing units (CPUs). Data may be information in a form suitable for use by a computer.

In the depicted embodiment, input/output interface 1005 may be configured to provide a communication interface to an input device, output device, or input and output device. UE 1000 may be configured to use an output device via input/output interface 1005. An output device may use the same type of interface port as an input device. For example, a USB port may be used to provide input to and output from UE 1000. The output device may be a speaker, a sound card, a video card, a display, a monitor, a printer, an actuator, an emitter, a smartcard, another output device, or any combination thereof. UE 1000 may be configured to use an input device via input/output interface 1005 to allow a user to capture information into UE 1000. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1009 may be configured to provide a communication interface to RF components such as a transmitter, a receiver, and an antenna. Network connection interface 1011 may be configured to provide a communication interface to network 1043a. Network 1043a may encompass wired and/or wireless networks such as a local-area network (LAN), a wide-area network (WAN), a computer network, a wireless network, a telecommunications network, another like network or any combination thereof. For example, network 1043a may comprise a Wi-Fi network. Network connection interface 1011 may be configured to include a receiver and a transmitter interface used to communicate with one or more other devices over a communication network according to one or more communication protocols, such as Ethernet, TCP/IP, SONET, ATM, or the like. Network connection interface 1011 may implement receiver and transmitter functionality appropriate to the communication network links (e.g., optical, electrical, and the like). The transmitter and receiver functions may share circuit components, software or firmware, or alternatively may be implemented separately.

RAM 1017 may be configured to interface via bus 1002 to processing circuitry 1001 to provide storage or caching of data or computer instructions during the execution of software programs such as the operating system, application programs, and device drivers. ROM 1019 may be configured to provide computer instructions or data to processing circuitry 1001. For example, ROM 1019 may be configured to store invariant low-level system code or data for basic system functions such as basic input and output (I/O), startup, or reception of keystrokes from a keyboard that are stored in a non-volatile memory. Storage medium 1021 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1021 may be configured to include operating system 1023, application program 1025 such as a web browser application, a widget or gadget engine or another application, and data file 1027. Storage medium 1021 may store, for use by UE 1000, any of a variety of various operating systems or combinations of operating systems.

Storage medium 1021 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1021 may allow UE 1000 to access computer-executable instructions, application programs or the like, stored on transitory or non-transitory memory media, to off-load data, or to upload data. An article of manufacture, such as one utilizing a communication system may be tangibly embodied in storage medium 1021, which may comprise a device readable medium.

In FIG. 10, processing circuitry 1001 may be configured to communicate with network 1043b using communication subsystem 1031. Network 1043a and network 1043b may be the same network or networks or different network or networks. Communication subsystem 1031 may be configured to include one or more transceivers used to communicate with network 1043b. For example, communication subsystem 1031 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1033 and/or receiver 1035 to implement transmitter or receiver functionality, respectively, appropriate to the RAN links (e.g., frequency allocations and the like). Further, transmitter 1033 and receiver 1035 of each transceiver may share circuit components, software or firmware, or alternatively may be implemented separately.

In the illustrated embodiment, the communication functions of communication subsystem 1031 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1031 may include cellular communication, Wi-Fi communication, Bluetooth communication, and GPS communication. Network 1043b may encompass wired and/or wireless networks such as a local-area network (LAN), a wide-area network (WAN), a computer network, a wireless network, a telecommunications network, another like network or any combination thereof. For example, network 1043b may be a cellular network, a Wi-Fi network, and/or a near-field network. Power source 1013 may be configured to provide alternating current (AC) or direct current (DC) power to components of UE 1000.

The features, benefits and/or functions described herein may be implemented in one of the components of UE 1000 or partitioned across multiple components of UE 1000. Further, the features, benefits, and/or functions described herein may be implemented in any combination of hardware, software or firmware. In one example, communication subsystem 1031 may be configured to include any of the components described herein. Further, processing circuitry 1001 may be configured to communicate with any of such components over bus 1002. In another example, any of such components may be represented by program instructions stored in memory that when executed by processing circuitry 1001 perform the corresponding functions described herein. In another example, the functionality of any of such components may be partitioned between processing circuitry 1001 and communication subsystem 1031. In another example, the non-computationally intensive functions of any of such components may be implemented in software or firmware and the computationally intensive functions may be implemented in hardware.

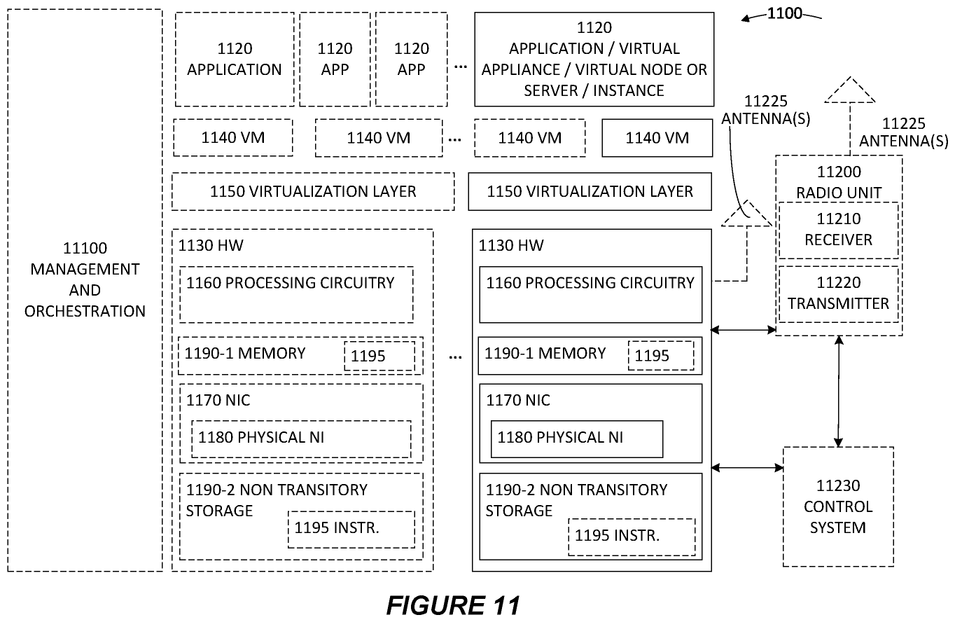

FIG. 11 is a schematic block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1100 hosted by one or more of hardware nodes 1130. Further, in embodiments in which the virtual node is not a radio access node or does not require radio connectivity (e.g., a core network node), then the network node may be entirely virtualized.

The functions may be implemented by one or more applications 1120 (which may alternatively be called software instances, virtual appliances, network functions, virtual nodes, virtual network functions, etc.) operative to implement some of the features, functions, and/or benefits of some of the embodiments disclosed herein. Applications 1120 are run in virtualization environment 1100 which provides hardware 1130 comprising processing circuitry 1160 and memory 1190. Memory 1190 contains instructions 1195 executable by processing circuitry 1160 whereby application 1120 is operative to provide one or more of the features, benefits, and/or functions disclosed herein.

Virtualization environment 1100, comprises general-purpose or special-purpose network hardware devices 1130 comprising a set of one or more processors or processing circuitry 1160, which may be commercial off-the-shelf (COTS) processors, dedicated Application Specific Integrated Circuits (ASICs), or any other type of processing circuitry including digital or analog hardware components or special purpose processors. Each hardware device may comprise memory 1190-1 which may be non-persistent memory for temporarily storing instructions 1195 or software executed by processing circuitry 1160. Each hardware device may comprise one or more network interface controllers (NICs) 1170, also known as network interface cards, which include physical network interface 1180. Each hardware device may also include non-transitory, persistent, machine-readable storage media 1190-2 having stored therein software 1195 and/or instructions executable by processing circuitry 1160. Software 1195 may include any type of software including software for instantiating one or more virtualization layers 1150 (also referred to as hypervisors), software to execute virtual machines 1140 as well as software allowing it to execute functions, features and/or benefits described in relation with some embodiments described herein.

Virtual machines 1140, comprise virtual processing, virtual memory, virtual networking or interface and virtual storage, and may be run by a corresponding virtualization layer 1150 or hypervisor. Different embodiments of the instance of virtual appliance 1120 may be implemented on one or more of virtual machines 1140, and the implementations may be made in different ways.

During operation, processing circuitry 1160 executes software 1195 to instantiate the hypervisor or virtualization layer 1150, which may sometimes be referred to as a virtual machine monitor (VMM). Virtualization layer 1150 may present a virtual operating platform that appears like networking hardware to virtual machine 1140.

As shown in FIG. 11, hardware 1130 may be a standalone network node with generic or specific components. Hardware 1130 may comprise antenna 11225 and may implement some functions via virtualization. Alternatively, hardware 1130 may be part of a larger cluster of hardware (e.g. such as in a data center or customer premise equipment (CPE)) where many hardware nodes work together and are managed via management and orchestration (MANO) 11100, which, among others, oversees lifecycle management of applications 1120.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1140 may be a software implementation of a physical machine that runs programs as if they were executing on a physical, non-virtualized machine. Each of virtual machines 1140, and that part of hardware 1130 that executes that virtual machine, be it hardware dedicated to that virtual machine and/or hardware shared by that virtual machine with others of the virtual machines 1140, forms a separate virtual network elements (VNE).

Still in the context of NFV, Virtual Network Function (VNF) is responsible for handling specific network functions that run in one or more virtual machines 1140 on top of hardware networking infrastructure 1130 and corresponds to application 1120 in FIG. 11.

In some embodiments, one or more radio units 11200 that each include one or more transmitters 11220 and one or more receivers 11210 may be coupled to one or more antennas 11225. Radio units 11200 may communicate directly with hardware nodes 1130 via one or more appropriate network interfaces and may be used in combination with the virtual components to provide a virtual node with radio capabilities, such as a radio access node or a base station.

In some embodiments, some signalling can be effected with the use of control system 11230 which may alternatively be used for communication between the hardware nodes 1130 and radio units 11200.

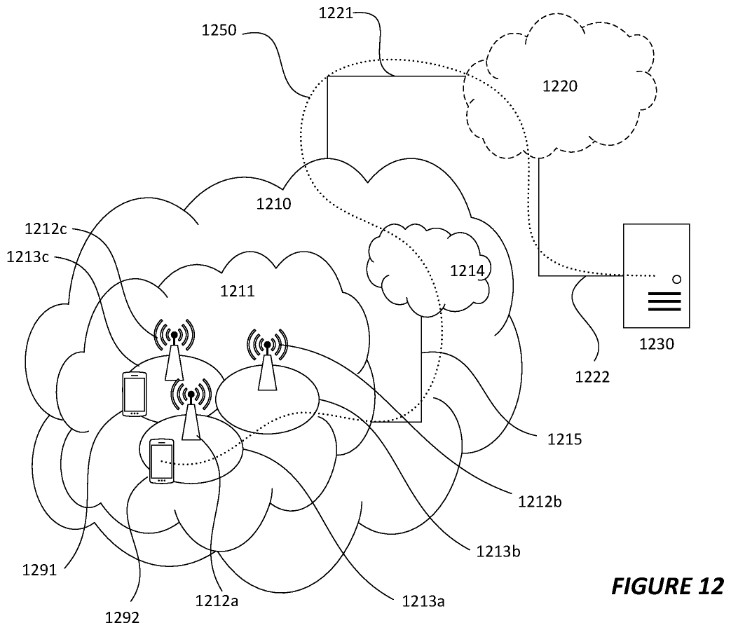

FIG. 12 illustrates a telecommunication network connected via an intermediate network to a host computer in accordance with some embodiments. In particular, with reference to FIG. 12, in accordance with an embodiment, a communication system includes telecommunication network 1210, such as a 3GPP-type cellular network, which comprises access network 1211, such as a radio access network, and core network 1214. Access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to core network 1214 over a wired or wireless connection 1215. A first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

Telecommunication network 1210 is itself connected to host computer 1230, which may be embodied in the hardware and/or software of a standalone server, a cloud-implemented server, a distributed server or as processing resources in a server farm. Host computer 1230 may be under the ownership or control of a service provider, or may be operated by the service provider or on behalf of the service provider. Connections 1221 and 1222 between telecommunication network 1210 and host computer 1230 may extend directly from core network 1214 to host computer 1230 or may go via an optional intermediate network 1220. Intermediate network 1220 may be one of, or a combination of more than one of, a public, private or hosted network; intermediate network 1220, if any, may be a backbone network or the Internet; in particular, intermediate network 1220 may comprise two or more sub-networks (not shown).

The communication system of FIG. 12 as a whole enables connectivity between the connected UEs 1291, 1292 and host computer 1230. The connectivity may be described as an over-the-top (OTT) connection 1250. Host computer 1230 and the connected UEs 1291, 1292 are configured to communicate data and/or signaling via OTT connection 1250, using access network 1211, core network 1214, any intermediate network 1220 and possible further infrastructure (not shown) as intermediaries. OTT connection 1250 may be transparent in the sense that the participating communication devices through which OTT connection 1250 passes are unaware of routing of uplink and downlink communications. For example, base station 1212 may not or need not be informed about the past routing of an incoming downlink communication with data originating from host computer 1230 to be forwarded (e.g., handed over) to a connected UE 1291. Similarly, base station 1212 need not be aware of the future routing of an outgoing uplink communication originating from the UE 1291 towards the host computer 1230.

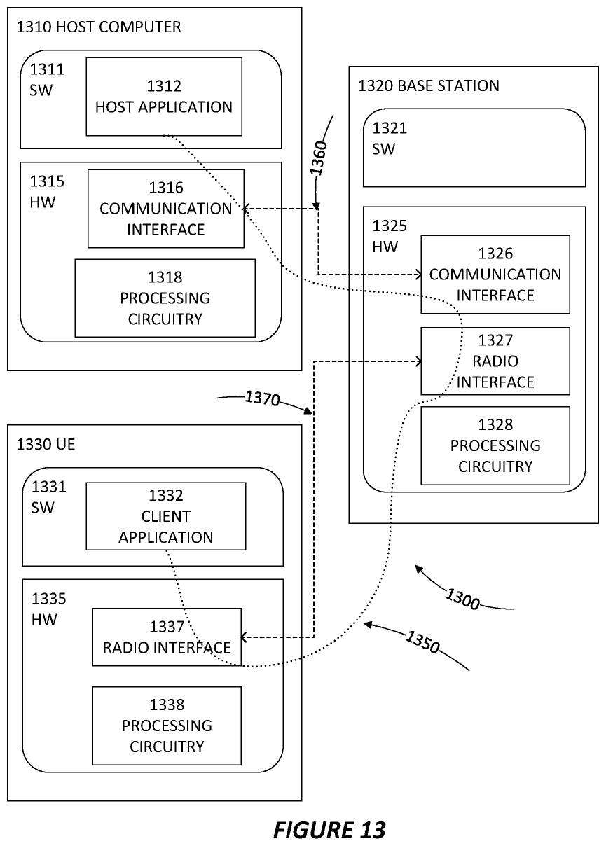

Example implementations, in accordance with an embodiment, of the UE, base station and host computer discussed in the preceding paragraphs will now be described with reference to FIG. 13. FIG. 13 illustrates host computer communicating via a base station with a user equipment over a partially wireless connection in accordance with some embodiments In communication system 1300, host computer 1310 comprises hardware 1315 including communication interface 1316 configured to set up and maintain a wired or wireless connection with an interface of a different communication device of communication system 1300. Host computer 1310 further comprises processing circuitry 1318, which may have storage and/or processing capabilities. In particular, processing circuitry 1318 may comprise one or more programmable processors, application-specific integrated circuits, field programmable gate arrays or combinations of these (not shown) adapted to execute instructions. Host computer 1310 further comprises software 1311, which is stored in or accessible by host computer 1310 and executable by processing circuitry 1318. Software 1311 includes host application 1312. Host application 1312 may be operable to provide a service to a remote user, such as UE 1330 connecting via OTT connection 1350 terminating at UE 1330 and host computer 1310. In providing the service to the remote user, host application 1312 may provide user data which is transmitted using OTT connection 1350.

Communication system 1300 further includes base station 1320 provided in a telecommunication system and comprising hardware 1325 enabling it to communicate with host computer 1310 and with UE 1330. Hardware 1325 may include communication interface 1326 for setting up and maintaining a wired or wireless connection with an interface of a different communication device of communication system 1300, as well as radio interface 1327 for setting up and maintaining at least wireless connection 1370 with UE 1330 located in a coverage area (not shown in FIG. 13) served by base station 1320. Communication interface 1326 may be configured to facilitate connection 1360 to host computer 1310. Connection 1360 may be direct or it may pass through a core network (not shown in FIG. 13) of the telecommunication system and/or through one or more intermediate networks outside the telecommunication system. In the embodiment shown, hardware 1325 of base station 1320 further includes processing circuitry 1328, which may comprise one or more programmable processors, application-specific integrated circuits, field programmable gate arrays or combinations of these (not shown) adapted to execute instructions. Base station 1320 further has software 1321 stored internally or accessible via an external connection.

Communication system 1300 further includes UE 1330 already referred to. Its hardware 1335 may include radio interface 1337 configured to set up and maintain wireless connection 1370 with a base station serving a coverage area in which UE 1330 is currently located. Hardware 1335 of UE 1330 further includes processing circuitry 1338, which may comprise one or more programmable processors, application-specific integrated circuits, field programmable gate arrays or combinations of these (not shown) adapted to execute instructions. UE 1330 further comprises software 1331, which is stored in or accessible by UE 1330 and executable by processing circuitry 1338. Software 1331 includes client application 1332. Client application 1332 may be operable to provide a service to a human or non-human user via UE 1330, with the support of host computer 1310. In host computer 1310, an executing host application 1312 may communicate with the executing client application 1332 via OTT connection 1350 terminating at UE 1330 and host computer 1310. In providing the service to the user, client application 1332 may receive request data from host application 1312 and provide user data in response to the request data. OTT connection 1350 may transfer both the request data and the user data. Client application 1332 may interact with the user to generate the user data that it provides.

It is noted that host computer 1310, base station 1320 and UE 1330 illustrated in FIG. 13 may be similar or identical to host computer 1230, one of base stations 1212a, 1212b, 1212c and one of UEs 1291, 1292 of FIG. 12, respectively. This is to say, the inner workings of these entities may be as shown in FIG. 13 and independently, the surrounding network topology may be that of FIG. 12.

In FIG. 13, OTT connection 1350 has been drawn abstractly to illustrate the communication between host computer 1310 and UE 1330 via base station 1320, without explicit reference to any intermediary devices and the precise routing of messages via these devices. Network infrastructure may determine the routing, which it may be configured to hide from UE 1330 or from the service provider operating host computer 1310, or both. While OTT connection 1350 is active, the network infrastructure may further take decisions by which it dynamically changes the routing (e.g., on the basis of load balancing consideration or reconfiguration of the network).

Wireless connection 1370 between UE 1330 and base station 1320 is in accordance with the teachings of the embodiments described throughout this disclosure. One or more of the various embodiments improve the performance of OTT services provided to UE 1330 using OTT connection 1350, in which wireless connection 1370 forms the last segment.

A measurement procedure may be provided for the purpose of monitoring data rate, latency and other factors on which the one or more embodiments improve. There may further be an optional network functionality for reconfiguring OTT connection 1350 between host computer 1310 and UE 1330, in response to variations in the measurement results. The measurement procedure and/or the network functionality for reconfiguring OTT connection 1350 may be implemented in software 1311 and hardware 1315 of host computer 1310 or in software 1331 and hardware 1335 of UE 1330, or both. In embodiments, sensors (not shown) may be deployed in or in association with communication devices through which OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of OTT connection 1350 may include message format, retransmission settings, preferred routing etc.; the reconfiguring need not affect base station 1320, and it may be unknown or imperceptible to base station 1320. Such procedures and functionalities may be known and practiced in the art. In certain embodiments, measurements may involve proprietary UE signaling facilitating host computer 1310's measurements of throughput, propagation times, latency and the like. The measurements may be implemented in that software 1311 and 1331 causes messages to be transmitted, in particular empty or ‘dummy’ messages, using OTT connection 1350 while it monitors propagation times, errors etc.

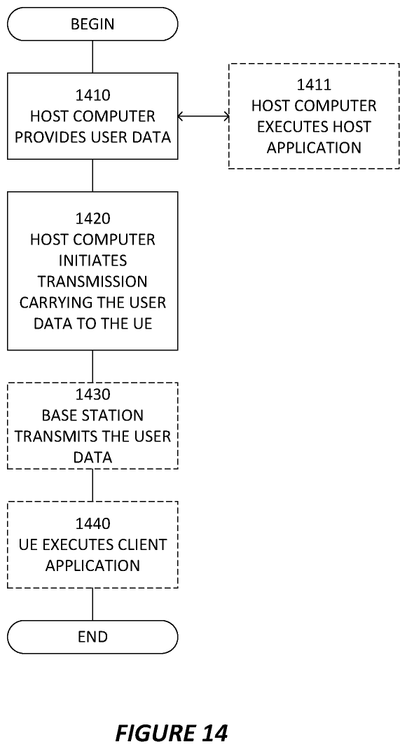

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1410, the host computer provides user data. In substep 1411 (which may be optional) of step 1410, the host computer provides the user data by executing a host application. In step 1420, the host computer initiates a transmission carrying the user data to the UE. In step 1430 (which may be optional), the base station transmits to the UE the user data which was carried in the transmission that the host computer initiated, in accordance with the teachings of the embodiments described throughout this disclosure. In step 1440 (which may also be optional), the UE executes a client application associated with the host application executed by the host computer.

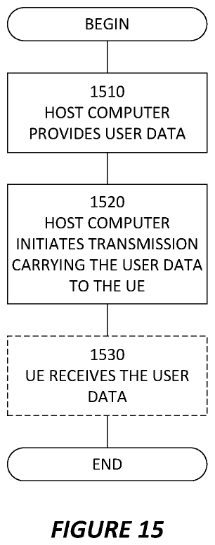

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1510 of the method, the host computer provides user data. In an optional substep (not shown) the host computer provides the user data by executing a host application. In step 1520, the host computer initiates a transmission carrying the user data to the UE. The transmission may pass via the base station, in accordance with the teachings of the embodiments described throughout this disclosure. In step 1530 (which may be optional), the UE receives the user data carried in the transmission.

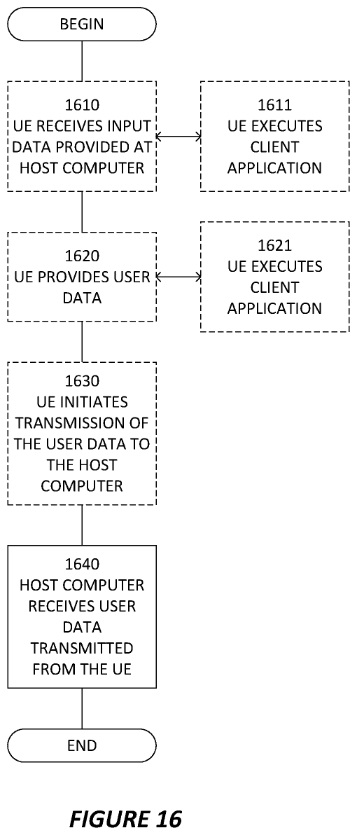

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1610 (which may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

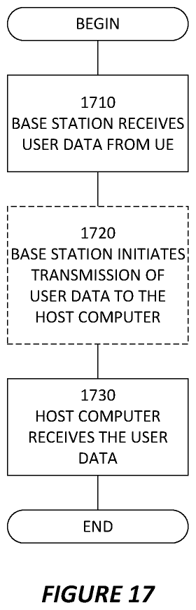

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer.

The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate.

Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1-66. (canceled)

67. A method comprising:
detecting a targeted signature over time in a Doppler spread and/or an angular spread associated with a wireless communication device; and
based on detecting the targeted signature, detecting a transition by the wireless communication device between an indoor environment and an outdoor environment.

68. The method of claim 67, wherein said detecting comprises detecting a targeted signature over time in a Doppler spread associated with the wireless communication device.

69. The method of claim 68, wherein detecting the targeted signature over time in the Doppler spread comprises:
detecting a first sub-signature in the Doppler spread during a first time period;
detecting a second sub-signature in the Doppler spread during a second time period after the first time period; and
detecting a third sub-signature in the Doppler spread during a third time period after the second time period;
wherein the first, second, and third sub-signatures are sub-signatures of the targeted signature.

70. The method of claim 69, wherein:
the first sub-signature in the Doppler spread is values of the Doppler spread being greater than or equal to a first upper threshold;
the second sub-signature in the Doppler spread is values of the Doppler spread being less than or equal to a lower threshold; and
the third sub-signature in the Doppler spread is values of the Doppler spread being greater than or equal to a second upper threshold, wherein the first and second upper thresholds coincide or are different.

71. The method of claim 67, wherein said detecting comprises detecting a targeted signature over time in an angular spread associated with the wireless communication device.

72. The method of claim 71, wherein the targeted signature over time in the angular spread comprises values of the angular spread changing by at least a threshold amount over the course of a maximum time period.

73. The method of claim 67, further comprising, responsive to detecting the transition, detecting an indoor signature or an outdoor signature over time in the Doppler spread or the angular spread associated with the wireless communication device, and determining whether the wireless communication device is in an indoor environment or an outdoor environment based respectively on whether the indoor signature or the outdoor signature is detected.

74. The method of claim 73, wherein the indoor signature comprises values of the angular spread being greater before the transition than after the transition, and wherein the outdoor signature comprises values of the angular spread being smaller before the transition than after the transition.

75. The method of claim 74, wherein determining whether the wireless communication device is in an indoor environment or an outdoor environment is based further on whether a received signal power for the wireless communication device before the transition is greater or less than a received signal power for the wireless communication device after the transition.

76. The method of claim 67, further comprising, based on detecting the transition by the wireless communication device between an indoor environment and an outdoor environment:
adapting one or more parameters that govern wireless communication to and/or from the wireless communication device; and/or
adjusting resources allocated to the wireless communication device; and/or
triggering a decision about whether to hand over the wireless communication device between network nodes.

77. The method of claim 67, wherein the method is performed by the wireless communication device and wherein the method further comprises reporting, to a network node, the occurrence of the detected transition and/or a presence of the wireless communication device in the indoor environment or the outdoor environment.

78. Wireless communication equipment comprising:
communication circuitry; and
processing circuitry configured to:
detect a targeted signature over time in a Doppler spread and/or an angular spread associated with a wireless communication device; and
based on detecting the targeted signature, detect a transition by the wireless communication device between an indoor environment and an outdoor environment.

79. The wireless communication equipment of claim 78, wherein the processing circuitry is configured to detect the targeted signature over time in the Doppler spread associated with the wireless communication device.

80. The wireless communication equipment of claim 79, wherein the processing circuitry is configured to:
detect a first sub-signature in the Doppler spread during a first time period;
detect a second sub-signature in the Doppler spread during a second time period after the first time period; and
detect a third sub-signature in the Doppler spread during a third time period after the second time period;
wherein the first, second, and third sub-signatures are sub-signatures of the targeted signature.

81. The wireless communication equipment of claim 80, wherein:
the first sub-signature in the Doppler spread is values of the Doppler spread being greater than or equal to a first upper threshold;
the second sub-signature in the Doppler spread is values of the Doppler spread being less than or equal to a lower threshold; and
the third sub-signature in the Doppler spread is values of the Doppler spread being greater than or equal to a second upper threshold, wherein the first and second upper thresholds coincide or are different.

82. The wireless communication equipment of claim 78, wherein the processing circuitry is configured to detect a targeted signature over time in an angular spread associated with the wireless communication device.

83. The wireless communication equipment of claim 82, wherein the targeted signature over time in the angular spread comprises values of the angular spread changing by at least a threshold amount over the course of a maximum time period.

84. The wireless communication equipment of claim 78, wherein the processing circuitry is configured to, responsive to detecting the transition, detect an indoor signature or an outdoor signature over time in the Doppler spread or the angular spread associated with the wireless communication device, and determine whether the wireless communication device is in an indoor environment or an outdoor environment based respectively on whether the indoor signature or the outdoor signature is detected.

85. The wireless communication equipment of claim 78, wherein the processing circuitry is configured to, based on detecting the transition by the wireless communication device between an indoor environment and an outdoor environment:
adapt one or more parameters that govern wireless communication to and/or from the wireless communication device; and/or
adjust resources allocated to the wireless communication device; and/or
trigger a decision about whether to hand over the wireless communication device between network nodes.

86. The wireless communication equipment of claim 78, wherein the wireless communication equipment is comprised in the wireless communication device and wherein the processing circuitry is configured to report, to a network node, the occurrence of the detected transition and/or a presence of the wireless communication device in the indoor environment or the outdoor environment.
